(19) United States
(12) Patent Application Publication
(10) Pub. No.: US 2014/0287393 A1
(43) Pub. Date: Sep. 25, 2014

(54) SYSTEM AND METHOD FOR THE EVALUATION OF OR IMPROVEMENT OF MINIMALLY INVASIVE SURGERY SKILLS

(71) Applicants: Rajesh Kumar, Baltimore, MD (US); Gregory D. Hager, Baltimore, MD (US); Amod S. Jog, Baltimore, MD (US); David D. Yuh, Madison, CT (US)

(72) Inventors: Rajesh Kumar, Baltimore, MD (US); Gregory D. Hager, Baltimore, MD (US); Amod S. Jog, Baltimore, MD (US); David D. Yuh, Madison, CT (US)

(73) Assignee: THE JOHNS HOPKINS UNIVERSITY, BALTIMORE, MD (US)

(21) Appl. No.: 13/883,516

(22) PCT Filed: May 6, 2011
(86) PCT No.: PCT/US11/35627

§ 371 Date: Oct. 7, 2013

Related U.S. Application Data
(60) Provisional application No. 61/410,150, filed on Nov. 4, 2010.

(51) Int. Cl. G09B 23/28; G09B 5/02

(52) U.S. Cl. CPC G09B 23/28; G09B 5/02
USPC 434/262

(57) ABSTRACT

A system to assist in at least one of the evaluation of or the improvement of skills to perform minimally invasive surgery includes a minimally invasive surgical system, a video system arranged to record at least one of a user's interaction with the minimally invasive surgical system or tasks performed with the minimally invasive surgical system, and a data storage and processing system in communication with the minimally invasive surgical system and in communication with the video system. The minimally invasive surgical system provides at least one of motion data, ergonomics adjustment data, electrical interface interaction data or mechanical interface interaction data of at least a component of the minimally invasive surgical system in conjunction with time registered video signals from the video system. The data storage and processing system processes the at least one of motion data, ergonomics adjustment data, electrical interface interaction data or mechanical interface interaction data to provide a performance metric in conjunction with the time registered video signals to be made available to an expert for evaluation.

### CROSS-REFERENCE OF RELATED APPLICATION

This application claims priority to U.S. Provisional Application No. 61/410,150, filed Nov. 4, 2010, the entire contents of which are hereby incorporated by reference.

This invention was made with Government support under Grant No. 1R21EB009143-01A1 awarded by NIH and Grant Nos. 0941362, and 0931805 awarded by the National Science Foundation. The U.S. Government has certain rights in this invention.

### BACKGROUND

1. Field of Invention

The field of the currently claimed embodiments of this invention relates to systems, methods and software for at least one of the evaluation of or the improvement of skills to perform minimally invasive surgery.

2. Discussion of Related Art

In recent years, there have been significant advances in many surgical procedures including minimally invasive surgical procedures. However, along with these advances, more and more complex surgical instruments and tools and combined surgical equipment require skill in both the operation of the tools and equipment, as well as performing the particular surgical task. Previously, very little had been known about the structure of technical surgical skill, its acquisition independent of surgical task and technique, or what level of variability existed among experienced practitioners. Yet, it is well-accepted that technical surgical skill is a crucial element in the outcome of many surgical procedures. Indeed, death due to iatrogenic causes is estimated to be 44,000 to 98,000 cases per year (Kohn L, ed, Corrigan J, ed, Donaldson M, ed.; To Err Is Human: Building a Safer Health System; National Academy Press; 1999). A separate study (Zhan C, Miller M. Excess length of stay, charges, and mortality attributable to medical injuries during hospitalization; JAMA; Vol. 290(14):1868-1874, 2003) reports over 32,000 mostly surgery-related deaths. Some portion of this is due to technical errors. It is unclear what additional impact technical skill has on surgical outcomes and morbidity. At the same time, new pressures to reduce the hours that residents work, and on health care costs overall demand increased efficiency in the teaching of surgical skill (Fletcher, K, Underwood W. Davis, S, Mangrulkar, R, McMahon, L, Saint, S; Effects of work hour reduction on residents' lives—a systematic review; JAMA; Vol. 294(9), pp. 1088-1100, 2005).

The complex minimally invasive surgical systems now in wide use require substantial training for the surgeon to develop the necessary skills. However, current training systems merely encourage the trainee to perform the same tasks over and over to achieve a better score. Therefore, there remains a need for improved systems and methods for at least one of the evaluation of or the improvement of skills to perform minimally invasive surgery.

### SUMMARY

A system to assist in at least one of the evaluation of or the improvement of skills to perform minimally invasive surgery according to some embodiments of the current invention includes a minimally invasive surgical system, a video system arranged to record at least one of a user's interaction with the minimally invasive surgical system or tasks performed with the minimally invasive surgical system, and a data storage and processing system in communication with the minimally invasive surgical system and in communication with the video system. The minimally invasive surgical system provides at least one of motion data, ergonomics adjustment data, electrical interface interaction data or mechanical interface interaction data of at least a component of the minimally invasive surgical system in conjunction with time registered video signals from the video system. The data storage and processing system processes the at least one of motion data, ergonomics adjustment data, electrical interface interaction data or mechanical interface interaction data to provide a performance metric in conjunction with the time registered video signals to be made available to an expert for evaluation.

A method for evaluating and assisting in the improvement of minimally invasive surgical skills according to some embodiments of the current invention includes recording, in a tangible medium, at least one of motion data, ergonomics adjustment data, electrical interface interaction data or mechanical interface interaction data of at least a component of a minimally invasive surgical system while in use; recording, in a tangible medium, video of at least the component of the minimally invasive surgical system in conjunction with the recording at least one of motion data, ergonomics adjustment data, electrical interface interaction data or mechanical interface interaction data to provide time registered video signals; and processing the at least one of motion data, ergonomics adjustment data, electrical interface interaction data or mechanical interface interaction data on a data processing system to provide a performance metric in conjunction with the time-registered video signals to be made available to an expert for evaluation.

A tangible machine-readable storage medium according to some embodiments of the current invention includes stored instructions, which when executed by a data processing system, causes the data processing system to perform operations that include receiving at least one of motion data, ergonomics adjustment data, electrical interface interaction data or mechanical interface interaction data of at least a component of a minimally invasive surgical system; receiving non-transient, time-registered video signals of at least the component of the minimally invasive surgical system in conjunction with the at least one of motion data, ergonomics adjustment data, electrical interface interaction data or mechanical interface interaction data; and processing the at least one of motion data, ergonomics adjustment data, electrical interface interaction data or mechanical interface interaction data on the data processing system to provide a performance metric in conjunction with the non-transient, time-registered video signals to be made available to an expert for evaluation.

### BRIEF DESCRIPTION OF THE DRAWINGS

Further objectives and advantages will become apparent from a consideration of the description, drawings, and examples.

FIG. 1 is a schematic illustration of a system to assist in at least one of the evaluation of or the improvement of skills to perform minimally invasive surgery according to an embodiment of the current invention.

FIG. 2 is a schematic illustration of a system to assist in at least one of the evaluation of or the improvement of skills to perform minimally invasive surgery according to an embodiment of the current invention.

FIG. 3 is a schematic illustration of robotic surgery system that can be adapted to include a system to assist in at least one of the evaluation of or the improvement of skills to perform minimally invasive surgery according to an embodiment of the current invention.

FIG. 4 shows a training board that can be used with a system to assist in at least one of the evaluation of or the improvement of skills to perform minimally invasive surgery according to an embodiment of the current invention.

FIG. 5 shows Cartesian position plots of the da Vinci left-hand manipulator, with identified surgical sub-tasks, during the performance of a four-throw suturing task for an expert surgeon.

FIG. 6 shows Cartesian position plots of the da Vinci left-hand manipulator, with identified surgical sub-tasks, during the performance of a four-throw suturing task for an novice surgeon.

FIG. 7 is a functional block diagram of a system used to recognize elementary tasks according to an embodiment of the current invention.

FIG. 8 shows a comparison of automatic segmentation of robot-assisted surgical motion with manual segmentations. Note that most errors occur at the transitions.

FIGS. 9A and 9B are plots illustrating how two features derived from Hidden Markov Model segmentation of task trials can be used to discriminate between an “intermediate” and “expert” user. FIG. 9A shows that the expert, as expected, performs the tasks in a manner that more closely matches the ideal model than the intermediate user, with the exception of sub-task A, which has too few data points for a reliable estimate. FIG. 9B shows that the amount of time spent in the different sub-tasks differs significantly between the expert and intermediate. With certain sub-tasks, such as positioning the needle (B), the expert spends considerably less time than the intermediate user. However, in others, such as pulling the suture (D), the expert is more careful and performs it in a more consistent manner (time).

FIG. 10 shows an archival system configuration with the da Vinci system (left), and Inanimate training pods for the first module of robotic surgery training (right), according to an embodiment of the current invention.

FIG. 11 shows Master and Camera workspaces used by experts (left, top and bottom), and a novice (right, top and bottom) respectively, according to an embodiment of the current invention.

FIGS. 12a-12h show learning curves based on time, master handle distance, and master handle volumes, and OSATS structured assessment measurements for individual tasks, and over all four tasks. Note the OSATS score scale has been inverted, and that experts task metrics appear in the bottom lower corner of the charts.

FIG. 13 shows projection of suturing instrument Cartesian velocity in 3 dimensions using PCA, according to an embodiment of the current invention. The blue observations are the expert trials, the green surgical trainees, and the brown the non-clinical users.

### DETAILED DESCRIPTION

Some embodiments of the current invention are discussed in detail below. In describing embodiments, specific terminology is employed for the sake of clarity. However, the invention is not intended to be limited to the specific terminology so selected. A person skilled in the relevant art will recognize that other equivalent components can be employed and other methods developed without departing from the broad concepts of the current invention. All references cited anywhere in this specification, including the Background and Detailed Description sections, are incorporated by reference as if each had been individually incorporated.

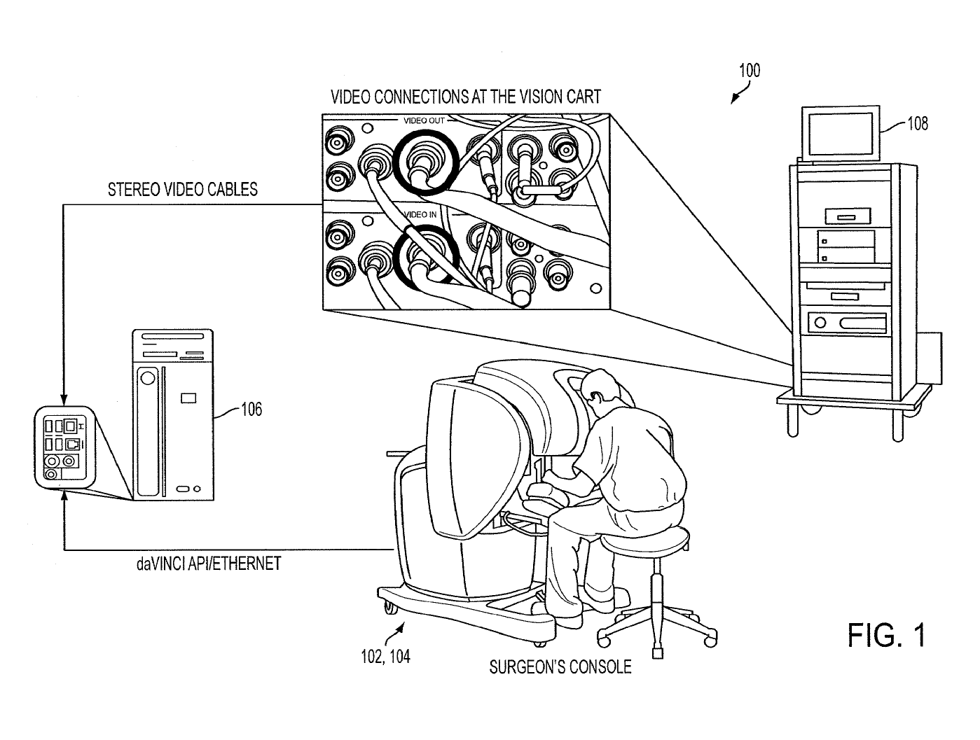

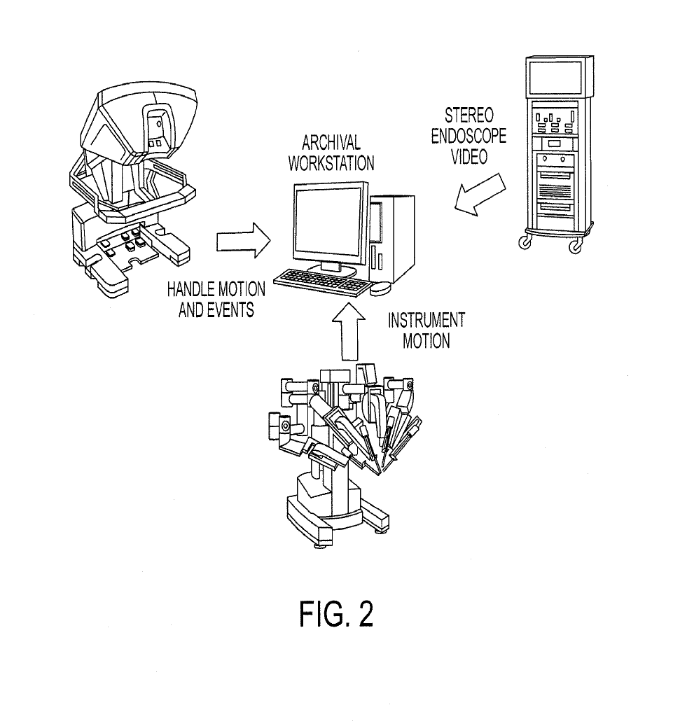

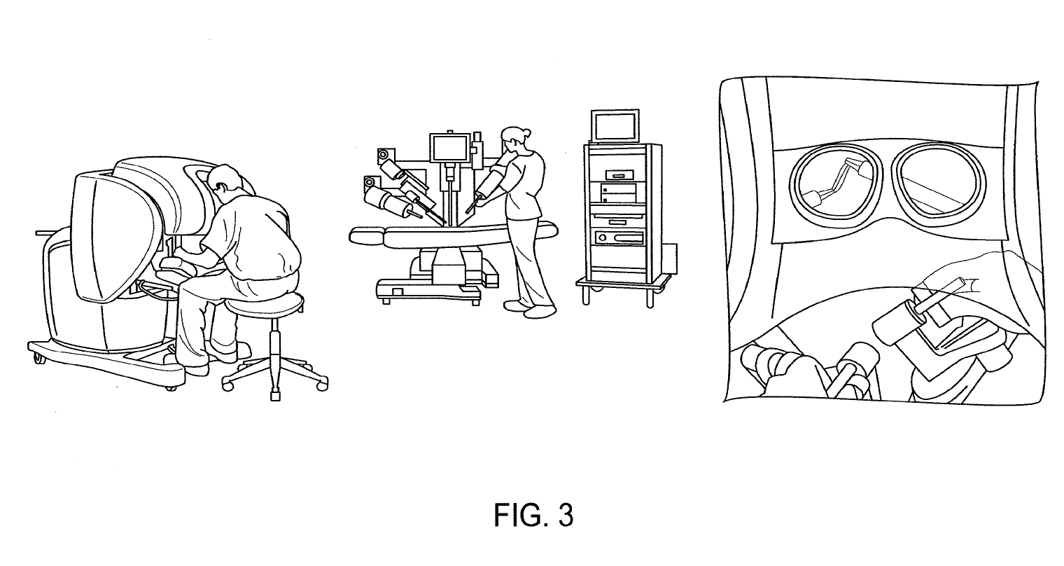

FIG. 1 is a schematic illustration of a system 100 to assist in at least one of the evaluation of or the improvement of skills to perform minimally invasive surgery. The system 100 has a minimally invasive surgical system 102, a video system 104 arranged to record at least one of a user's interaction with the minimally invasive surgical system or tasks performed with the minimally invasive surgical system, and a data storage and processing system 106 that is in communication with the minimally invasive surgical system 102 and in communication with the video system 104. In the example of FIG. 1, the minimally invasive surgical system 102 is a robotic surgery system and the video system 104 can be incorporated into the robotic system. However, in other embodiments, the video system 104 can also be arranged separately with one or more cameras. The video system 104 can also include one or more stereo cameras in some embodiments of the current invention. In FIG. 1, only the surgeon's console of the robotic surgery system 102 is shown. The robotic surgery system 102 can include additional components, such as shown in FIGS. 2 and 3, for example. FIG. 3 also shows a view of the surgeon's, or master, console including a partial view of master handles.

Although many of the particular examples in this specification will refer to a robotic surgery system as a possible minimally invasive surgery system, the general concepts of the current invention are not limited to that particular example. For example, other laparoscopic systems that do not employ a robotic system are intended to be included in the general scope of the current invention. Minimally invasive surgery systems may include endoscopes, catheters, trocars and/or a variety of associated tools, for example.

The minimally invasive surgical system 102 provides at least one of motion data, ergonomics adjustment data, electrical interface interaction data or mechanical interface interaction data of at least a component of the minimally invasive surgical system 100 in conjunction with time-registered video signals from the video system. The term “motion data” is intended to broadly include any data upon which one can determine a translational motion and/or rotational motion from at least one moment in time to another moment in time. For example, sensors such as, but not limited to, linear accelerometers and gyroscopes can provide position and orientation information of an object of interest. In addition, the position and orientation of an object at one moment in time and the position and orientation of the object at another moment in time can also provide motion data. However, the term “motion data” is not limited to only these examples. For example, in the case of a robotic minimally invasive surgery system, the motions of the tool arms, etc. are known since the sensors in the robotic system directly measure and report these motions.

The data storage and processing system 106 processes the at least one of motion data, ergonomics adjustment data, electrical interface interaction data or mechanical interface interaction data to provide a performance metric in conjunction with the time-registered video signals to be made available to an expert for evaluation. The term “expert” is intended to refer to a person who has a predetermined minimum level of knowledge and skill in the relevant surgical techniques and/or to an expert system (e.g., computerized system) that utilizes such information from said person to be considered proficient by a person versed in the surgical subject, and/or qualified to operate on humans in the surgical specialty by established standards. An expert system, as used herein, can also include information from more than one expert.

The data storage and processing system can be a combined system such as a laptop computer, a personal computer and/or a work station. The data storage system can also have separate data and storage components and/or multiple such components in combination. The data processor system can also include data storage arrays and/or multiprocessor data processors, for example. The data storage and processor system can also be a distributed system, either locally or over a network, such as a local area network or the internet. In addition, the components of the system 100 can be electrical or optical connections, wireless connections and can include local networks as well as wide area networks and/or the internet, for example. The minimally invasive surgical system 102 can include one or more surgical tool, for example.

In some embodiments, the minimally invasive surgical system 102 can be a tele-operated robotic surgery system that includes master handles and the motion data can include motion data of the master handles. In some embodiments, the minimally invasive surgical system 102 can be a tele-operated robotic surgery system that has a console that contains the master handles and the motion data can include a configuration of at least one of ergonomics, workspace, and visualization aspects of the console.

The system 100 can further include a display system 108 that is in communication with the data storage and processing system 106 to display the performance metric in conjunction with the time-registered video signals to be made available to the expert for evaluation. The display system can include any suitable display device such as, but not limited to, a CRT, LCD, LED and/or plasma display, for example. The display can be locally connected to the data storage and processing system 106, or can be remote over a network or wireless connection, for example. The display system 108 can also display the information from the data storage and processing system 106 either contemporaneously or later than the user's session. The system 100 can further include a second display system (not shown) that is in communication with the data storage and processing system 106 to display the expert evaluation in conjunction with the time registered video to the user. The second display system can include any suitable display device such as, but not limited to, a CRT, LCD, LED and/or plasma display, for example. The second display system can also be local or remote and display in real time or at a later time. The system 100 is not limited to one or two display systems and can have a greater plurality of display systems, as desired for the particular application.

The system 100 can further include an input device that is in communication with the data storage and processing system 106 to receive expert evaluation from the expert in correspondence with the performance metric and the time-registered video. The input device can be a key board, a mouse, a touch screen, or any other suitable data input peripheral device. The system 100 can also include a plurality of data input devices. The input device can be locally connected or can be connected to the data storage and processing system 106 over a network, such as, but not limited to, the internet.

In an embodiment of the current invention, the data storage and processing system 106 can be further configured to analyze task performances and provide automated evaluation and expert evaluation together with task video. The automated evaluation can include learning curves of task performance based on configurable task metrics according to some embodiments of the current invention. According to some embodiments of the current invention, the data storage and processing system 106 can be further configured to allow for specific aspects of the automated evaluation to be hidden from review to prevent introduction of bias or a focus on numerical aspects of the automated evaluation by a user, such as a trainee. The automated evaluation can include task-specific feedback for a subsequent, such as the next, training session according to some embodiments of the current invention. The automated evaluation can include specific objective feedback for both a mentor and the trainee, with the feedback for the mentor being different from the feedback to the trainee according to some embodiments of the current invention. The objective feedback can include task steps in which the trainee is identified to be deficient, according to some embodiments of the current invention. The objective feedback to the mentor can include a summary of trainee progress, learning curves, population-wide trends, comparison of the trainee to other trainees, training system limitations, supplies and materials status, and system maintenance issues, according to some embodiments of the current invention. The automated evaluation can be used to vary a training task complexity, according to some embodiments of the current invention. The automated evaluation can be used to vary a frequency of training, according to some embodiments of the current invention. The automated evaluation can be used to select training tasks for the next training session, according to some embodiments of the current invention.

According to some embodiments of the current invention, the processing system can be configured to perform methods for statistical analysis of skill classification, including identification of proficiency and deficiency. The skill classification can be binary, for example. For example, but not limited to, indicating (1) proficient, or (2) needs more training. In other embodiments, the skill classification can be multi-class or ordinal. For example, but not limited to: (1) novice, (2) intermediate, (3) proficient, (4) expert. According to some embodiments of the current invention, the skill classification can be based on at least one of a task statistic or a metric of skill. According to some embodiments of the current invention, the skill classification can be based on multiple classification methods.

According to some embodiments of the current invention, the man-machine interaction, ergonomics, and surgical task skills classification can be performed separately. According to some embodiments of the current invention, separate metrics of man-machine interaction, ergonomics and surgical task skills can be computed. According to some embodiments of the current invention, separate training tasks and difficulty levels can be used for man-machine interaction, ergonomics and surgical task skills.

Another embodiment of the current invention is directed to a method for evaluating and assisting in the improvement of minimally invasive surgical skills. The method includes recording, in a tangible medium, at least one of motion data, ergonomics adjustment data, electrical interface interaction data or mechanical interface interaction data of at least a component of a minimally invasive surgical system while in use. The method also includes recording, in a tangible medium, video of at least the component of the minimally invasive surgical system in conjunction with the recording at least one of motion data, ergonomics adjustment data, electrical interface interaction data or mechanical interface interaction data to provide time registered video signals. The method further includes processing the at least one of motion data, ergonomics adjustment data, electrical interface interaction data or mechanical interface interaction data on a data processing system to provide a performance metric in conjunction with the time-registered video signals to be made available to an expert for evaluation. The data processing can be, or can include portions of, the data storage and processing system 106 described above, for example.

Another embodiment of the current invention is directed to a tangible, machine-readable storage medium that has stored instructions, which when executed by a data processing system, causes the data processing system to perform operations. The operations include receiving at least one of motion data, ergonomics adjustment data, electrical interface interaction data or mechanical interface interaction data of at least a component of a minimally invasive surgical system; receiving non-transient, time-registered video signals of at least the component of the minimally invasive surgical system in conjunction with the at least one of motion data, ergonomics adjustment data, electrical interface interaction data or mechanical interface interaction data; and processing the at least one of motion data, ergonomics adjustment data, electrical interface interaction data or mechanical interface interaction data on the data processing system to provide a performance metric in conjunction with the non-transient, time-registered video signals to be made available to an expert for evaluation.

### EXAMPLES

The following examples are applications of some specific embodiments of the current invention. These are not intended to limit the general scope of the invention, which is defined by the claims.

Availability of new technology now affords us methods of measuring the completeness and effectiveness of technical skills during training that was not available in the past.

One of the difficulties in studying surgical skill is the instrumentation necessary to acquire precise measurements of tool use and tool motion during surgery. In this regard, the Intuitive Surgical da Vinci robotic surgery system provides a standardized, well-instrumented “laboratory” for studying surgical procedures in clinical operative settings. In contrast to simulated or instrumented real surgical environments, it allows surgical motions and clinical events to be recorded undisturbed and unmodified by experimental sensors and tools via its application programming interface (API). There are over 1700 installed da Vinci systems as of late 2010. Robotic radical prostatectomies are now the dominant modality of operation for removal of prostates with cancer, and conservative estimates of the total number of various procedures performed robotically are in several tens of thousands in the United States, and nearly a hundred thousand worldwide. The da Vinci, even though it is the only commercial robotic surgery system, is now widely available and operating at a clinical volume that makes the investigation of skill development a significant issue in quality of care. From a broader perspective, recording and analyzing such data provides a unique opportunity to study the fundamental structure and acquisition of technical skill for the broader practice of medicine in a non-invasive, cost-effective manner.

Robotic laparoscopic or minimally invasive surgery has become an established standard of care in several areas of surgical practice. In particular, robotic surgery has made great strides in urology (Elhage O, Murphy D, et al, Robotic urology in the United Kingdom: experience and overview of robotic-assisted cystectomy, Journal of Robotic Surgery, 1(4), pp. 235-242, 2008; Thaly R, Shah K, Patel V R, Applications of robots in urology, Journal of Robotic Surgery, 1(1), pp 3-17, 2007; Kumar R, Hemal A K, Menon M, Robotic renal and adrenal surgery: Present and future. BJU International, 96(3), pp. 244-249, 2005), gynecology (Boggess J F, Robotic surgery in gynecologic oncology: evolution of a new surgical paradigm; Journal of Robotic Surgery, 1(1), pp. 31-37, 2007), and cardiac surgery (Rodriguez E, Chitwood W R, Outcomes in robotic cardiac surgery, Journal of Robotic Surgery, 1(1), pp 19-23, 2007). Since its initial clinical approvals in the United States in 2000, the da Vinci robotic surgery system (Intuitive Surgical Inc. Sunnyvale, Calif.) has emerged as a widely accepted leader in minimally invasive robotic surgery platforms with over 1700 systems installed in 2010, up from over 700 systems in 2007, and around 500 in 2006. The community of robotically trained clinicians is now several thousand strong, and publishes widely, including in journals such as Journal of Robotic Surgery, focused specifically on robotic surgery. Intuitive Surgical has recently developed a residency program for robotic surgery in collaboration with several leading training institutions to improve surgical training and increase the number of trained clinicians rapidly.

Robotic Surgery Applications:

Prostate cancer is a highly prevalent disease; 1 in 6 men are expected to be diagnosed with it during their lifetime. The gold standard of care is radical retropubic prostatectomy. Benefits such as reduced pain, trauma and shorter recovery times led to establishment of laparoscopic techniques, but it is a complex procedure to perform minimally invasively. Common side effects of radical prostatectomy include erectile dysfunction and incontinence which also have psychological implications for the patient, apart from loss of function. Robotic surgery has gained wide acceptance in such complex procedures. Of the 75000 radical prostatectomies performed in the USA every year for the treatment of prostate cancer (Shuford M D, Robotically assisted laparoscopic radical prostatectomy: a brief review of outcomes, Proc. Baylor University Medical Center, 20(4), pp 354-356, 2007), the da Vinci is expected to have performed a majority (total over 50000 worldwide) in 2007 (Intuitive Surgical Inc, Presentation at the JP Morgan Healthcare Conference, website: http://www.intuitivesurgical.com, accessed December 2007) to become the dominant treatment for localized prostate cancer, up from 18,000 procedures performed using it in 2005 and 8500 in 2004 (Shuford). Recently presented large population and long-term studies (Badani K K, Kaul S, Menon M, Evolution of robotic radical prostatectomy: assessment after 2766 procedures, Cancer, 110(9), pp. 1951-8, 2007) have shown comparable or favorable performance of robotic methods. Robotic hysterectomies (Boggess; Diaz-Arrastia C, Jurnalov C et al., Laparoscopic hysterectomy using a computer-enhanced surgical robot, Surgical Endoscopy, 16(9), pp. 1271-1273, 2002) and complex gynecological procedures are gaining wider acceptance and may soon follow prostatectomies as the dominant procedure modality.

A large number of cardiac procedures including coronary artery bypass grafting (Rodriguez, et al; Novick R J, Fox S A, Kiaii B B, et al., Analysis of the learning curve in telerobotic beating heart coronary artery bypass grafting: A 90 patient experience, Annals of Thoracic Surgery, 76, pp. 749-753, 2003; Kappert U, Cichon R, Schneider J, et al, Closed-chest coronary artery surgery on the beating heart with the use of a robotic system, Journal of Thoracic and Cardiovascular Surgery, 120(4), pp. 809-811, 2000), atrial septal defect closure (Reichenspurner H, Boehm D H, Welz A, et al., 3D-video and robot-assisted minimally invasive ASD closure using the Port-Access techniques, Heart Surgery Forum, 1(2), pp. 104-106, 1998), and transmyocardial laser revascularization (Yuh D D, Simon B A, Fernandez-Bustamante A, et al, Totally endoscopic robot-assisted transmyocardial revascularization, Journal of Thoracic and Cardiovascular Surgery, 130(1), pp. 120-124, 2005) have been performed with the da Vinci. While the urology successes have not yet been replicated in all cardiac procedures due to the motion of the beating heart, physical constraints of the chest cavity, and drastic consequences of surgical error or delays in access, some cardiac procedures such as mitral valve repair (Rodriguez, et al; Chitwood W R, Current status of endoscopic and robotic mitral valve surgery. Annals of Thoracic Surgery, 79(6), pp. S2248-S2253, 2005) are becoming more prevalent. Improved technology, including methods and tools for stabilization may make other robotic cardiac procedures more common in the future.

Robotic procedures have also been performed in pediatrics (Sinha C K, Haddad M, Robot-assisted surgery in children: current status, Journal of Robotic Surgery, 1(4), pp. 243-246, 2008), neurological surgery (Bumm K, Wurm J, Rachinger J, et al, An automated robotic approach with redundant navigation for minimally invasive extended transsphenoidal skull base surgery. Minimally Invasive Neurosurgery, 48(3), pp. 159-164, 2005), and gastrointestinal surgery (Ballantyne G H, Telerobotic gastrointestinal surgery: phase 2-safety and efficacy, Surgical Endoscopy, 21(7), pp. 1054-1062, 2007) among several other surgical specialties. With other surgical platforms and tools in development, robotic surgery is likely to continue expanding its presence in surgical procedures.

The Da Vinci Robotic Surgery System:

The Da Vinci robotic surgery system includes a surgeon's console with a pair of master manipulators and their control systems, a patient cart with a set of patient side manipulators, and a cart housing the stereo endoscopic vision equipment (FIGS. 1-3). A variety of easily removable surgical instruments can be attached to the patient side manipulators, and can be manipulated from the master manipulators at the surgeon's console. Recent versions of the da Vinci can have four slave manipulators, with one dedicated to holding the stereo endoscopic camera. The slave manipulators can be activated to move in response to the motion of the master manipulators by using the foot pedals and switches on surgeon's console. The scaling of motion between the master manipulators and their corresponding slave motions can be adjusted using the buttons at the surgeon's console. With the instrument degrees of freedom included, the slave robots can have up to seven degrees of freedom, allowing greater dexterity at the tip than the human wrist.

Robotic Surgery Limitations:

The da Vinci is the only robotic surgery system commercially available. In addition to its substantial system cost (around 1.3 million US dollars) and maintenance expense (more than a hundred thousand US dollars per year) the cost of the disposable surgical tools is also known to be in thousands of dollars per procedure. As with any new technology, publications have noted a significant learning curve, with extensive laboratory practice required for clinical proficiency (Chitwood, et al; Novic, et al; Yohannes P, Rotariu P, Pinto P, et al, Comparison of robotic versus laparoscopic skill: is there a difference in the learning curve?, Urology, 60, pp. 39-45, 2002).

Da Vinci Application Programming Interface (API):

Complementary to its surgical uses, the da Vinci robotic system also provides a well instrumented robotic laboratory for measurement and assessment of various aspects of surgery and surgical training. The API (DiMaio, S, and Hasser, C, The da Vinci research interface, Workshop on Systems and Architectures for Computer Assisted Interventions, MICCAI 2008, Midas Journal, http://hdl.handle.net/10380/1464, accessed 11/2008) provides access to motion parameters of the camera, the instruments, and the master handles. The API, which operates (and can be enabled or disabled) independently of the clinical use, is an Ethernet interface that provides transparent access to motion vectors including joint angles, Cartesian position and velocity, gripper angle, and joint velocity and torque data. In addition, high quality time synchronized video can be acquired from the vision system for the stereo endoscopic channels. The da Vinci API also streams several clinical and system events, as they occur. This includes events to signal change of tools, start or end of master controlled surgical instrument motion, reconfiguration of master or slave workspace (master-clutch or slave-clutch), changes in camera field of view, among others. The API can be configured to stream data at various rates (typically up to 100 Hz) providing new manipulator data at better than common video acquisition rates.

Robotic Surgery Training:

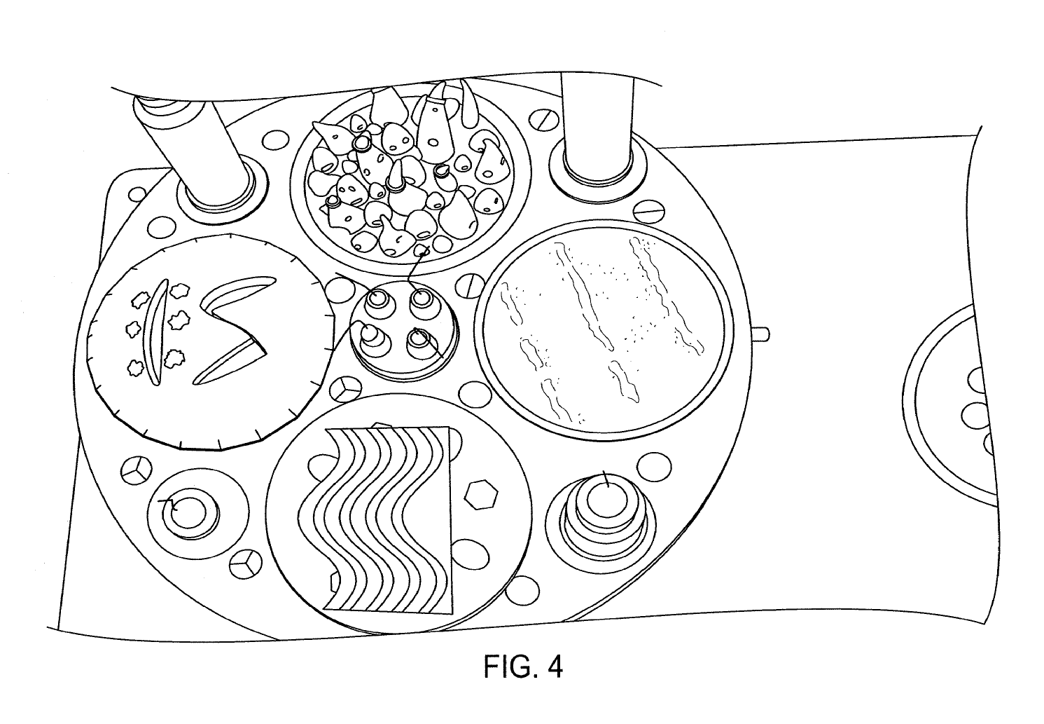

Robotic surgery orientation is performed using training pods such as the Chamberlain group robotic surgery training pods shown in FIG. 4. Training pods are available for all basic surgery skills such as cutting, suturing, and knot tying. Orientation is usually followed by surgery on closed models, and finally on animal models. After achieving proficiency on animal models, a surgeon is proctored and mentored during their first several human surgeries.

Prior Work in Skill Modeling and Assessment Using Automated Methods:

We are not aware of similar specific studies focusing on development of system operation and operator skills during surgical training. These skills also constitute a portion of skills required for clinical proficiency. Laparoscopic simulation and surgery training have used analysis of motion parameters in the past. This includes motion analysis using systems such as MIST-VR laparoscopic trainer (Gallagher A. G, Richie K., McClure M., McGuigan J.; Objective Psychomotor Skills Assessment of Experienced, Junior, and Novice Laparoscopists with Virtual Reality; World Journal of Surgery; Vol. 25 (11), pp. 1478-1483, 2001), or the electromagnetic tracker based Imperial College Surgical Assessment Device (ICSAD) (Darzi A, Mackay S, Skills assessment of surgeons, Surgery, 131(2), pp. 121-124, 2002) for measurement of surgical performance or acquisition of surgical skills. These studies often rely on a manual interpretation of recorded video data by an expert physician. Objective Structured Assessment of Technical Skills (OSATS) (Moorthy K, Munz Y, et al, Objective assessment of technical skills in surgery. BMJ, 327, pp. 1032-1037, 2003) based on motion data have also been performed based on daVinci API data (Hernandez J D, Bann S D, et al, Qualitative and quantitative analysis of the learning curve of a simulated surgical task on the da Vinci system, Surgical Endoscopy, 18, pp. 372-378, 2004) and have included an element of manual expert evaluation. Our group and collaborators (Verner L, Oleynikov D, et al, Measurements of the level of expertise using flight path analysis from da Vinci robotic surgical system, Medicine Meets Virtual Reality, 94, 2003; Lin H C, Shafran I, Yuh D D, Hager G D, Vision-Assisted Automatic Detection and Segmentation of Robot-Assisted Surgical Motions, Medicine Meets Virtual Reality, 2006) have also used the da Vinci API data for automatic segmentation and analysis of surgical motions.

A real need still exists for objective surgical training (Reznick R K; Teaching and testing technical skills; Am J Surg, Vol. 165, pp. 358-361, 1993; Reznick R K, and MacRae H; Teaching surgical skills-changes in the wind; New England Journal of Medicine; vol. 355(25); pp. 2664-2669, 2006). The skills learned on a bench top model in a classroom need to be identified and their transfer to real procedures validated in the operating room. Ericsson (Ericsson, K A, Krampe, R T, and Tesch-Romer, C; The role of deliberate practice in the acquisition of expert performance; Psychological Review, Vol 100(3), 363-406, 1993) argues that most surgeons do not reach true expertise and that there is a need for deliberate practice and feedback. There is a large body of published studies, including some from our group, that employ new technology (G Gallagher A. G, Richie K., McClure M., McGuigan J.; Objective Psychomotor Skills Assessment of Experienced, Junior, and Novice Laparoscopists with Virtual Reality; World Journal of Surgery; Vol. 25 (11), pp. 1478-1483, 2001; Gallagher A G, Satava R M, Virtual reality as a metric for the assessment of laparoscopic psychomotor skills, Surgical Endoscopy, 16(2), pp. 1746-1752, 2002; Lin H C, Shafran I, Yuh D D, Hager G D, Vision-Assisted Automatic Detection and Segmentation of Robot-Assisted Surgical Motions, Medicine Meets Virtual Reality, 2006; C. E. Reiley, T. Akinbiyi, D. Burschka, A. M. Okamura, C. Hasser, D. Yuh; Evaluation of Surgical Tasks using Sensory Substitution in Robot-Assisted Surgical Systems; The Journal of Thoracic and Cardiovascular Surgery; Vol. 135, Issue 1, pp. 196-202, 2008) to automatically analyze, model and assess surgical skills, training and transfer. These studies report that experienced surgeons perform surgical tasks significantly faster, more consistently, with lower error rates, and have more efficient movements of the surgical instruments. Some of these objective metrics are difficult to measure without extensive intrusion on surgical practice or without the use of additional technology. Measurement of others, such as efficiency of movement, is just not possible without such aids.

Rationale and Significance of this Work:

Our prior work and other published art shows that modern statistical learning and classification techniques, applied to large quantities of recorded data, have the potential to revolutionize training and assessment in surgery. Indeed, this is very similar to the revolution experienced by speech processing when a similar paradigm shift toward statistical modeling occurred. Clearly, the results of this study will be applicable to robotic surgery, where such data sets offer the additional possibly of many forms of ergonomic and mechanisms efficiency studies. The acquired data will facilitate studies that will also have broader implications for our understanding of the practice of surgery. The techniques and insights gained from this data will provide guidance on the development of teaching and assessment methodologies for traditional laparoscopic methods and may eventually even have implications for traditional open surgery.

### Example 1

In the following example according to an embodiment of the current invention, we used the da Vinci robotic system extensively for modeling and evaluating human surgical task performance. This included integration of new technology (Leven J, Burschka D, Kumar R, et al, DaVinci Canvas: A Telerobotic Surgical System with Integrated, Robot-Assisted, Laparoscopic Ultrasound Capability, Medical Image Computing and Computer Assisted Intervention, Springer Lecture Notes in Computer Science, 4190, pp 811-818, 2005; Burschka D, Corso J J, et al, Navigating Inner Space: 3-D Assistance for Minimally Invasive Surgery. Robotics and Autonomous System, 2005), development of new architectures (Hanly E J, Miller B E, Kumar R, et al, Mentoring console improves collaboration and teaching in surgical robotics, Journal of Laparoendoscopic and Advanced Surgical Techniques; 16(5), pp 445-451, 2006), as well as studies of human-robot interaction (C. E. Reiley, T. Akinbiyi, D. Burschka, A. M. Okamura, C. Hasser, D. Yuh; Evaluation of Surgical Tasks using Sensory Substitution in Robot-Assisted Surgical Systems; The Journal of Thoracic and Cardiovascular Surgery; Vol. 135, Issue 1, pp. 196-202, 2008; Hanley, et al.; Lin H C, Shafran I, Yuh D D, Hager G D, Vision-Assisted Automatic Detection and Segmentation of Robot-Assisted Surgical Motions, Medicine Meets Virtual Reality, 2006; Lin H C, Shafran I, et al, Towards Automatic Skill Evaluation: Detection and Segmentation of Robot-Assisted Surgical Motions, Computer Aided Surgery, 11(5), pp. 220-230, 2006; Lin H C, Shafran I, et al, Automatic detection and segmentation of robot-assisted surgical motions. Medical Image Computing and Computer Assisted Intervention, Springer Lecture Notes in Computer Science, 4190, pp. 802-810, 2005). We have also studied statistical modeling of user motion and/or force data, the effectiveness of robotic guidance on speed and accuracy of surgical tasks, and of various modalities of information feedback. Se also the following:
Voros, S, and Hager, G; Towards “real-Time” Tool-Tissue Interaction Detection in Robotically Assisted Laparoscopy; IEEE International Conference on Biomedical Robotics and Biomechatronics, pp. 562-567, 2008;
Kitagawa M, Dokko D, Okamura A M, Yuh D D, Effect of sensory substitution on suture manipulation forces for robotic surgical systems, Journal of Thoracic and Cardiovascular Surgery, 129, pp. 151-158, 2005;
Kitagawa M, Dokko D, Okamura A M, et al, Effect of sensory substitution on suture manipulation forces for surgical teleoperation, Medicine Meets Virtual Reality 12, pp 157-163, 2004;
Kitagawa M, Okamura A O, Bethea B T, et al, Analysis of suture manipulation forces for teleoperation with force feedback, Medical Image Computing and Computer Assisted Intervention, Springer Lecture Notes in Computer Science, 2488, pp. 155-162, 2002;
Bethea B T, Okamura A M, Kitagawa M, et al, Application of haptic feedback to robotic surgery, Journal of Laparoendoscopic and Advance Surgical Techniques, 14(3), 191-195, 2004; and
Moorthy K, Munz Y, et al, Objective assessment of technical skills in surgery. BMJ, 327, pp. 1032-1037, 2003.
   Data Recording with the Da Vinci Robot

We have developed a PC based software solution for data recording from the da Vinci systems according to some embodiments of the current invention. The application acquires data from the da Vinci API at a configurable rate. These quantitative measurements include tool, camera and master handle motion vectors including joint angles, velocity, and torque, Cartesian position and velocity, gripper angle, and synchronized stereo video data (“procedure data”). Data collected is synchronized across manipulators and video channels and time-stamped before archival. This example is compatible with the Intuitive Surgical's proprietary API library. The proprietary da Vinci API client application only captures motion vectors and initially produced text log files.

In addition, we have developed several task boards for use in structured data collection, an example of which is shown in FIG. 4. Each of the task boards is designed to be highly replicable. Thus far, boards have been designed for suturing, knot tying and needle passing. Data has been collected from laboratory (task board) settings, animal surgeries, and live human surgeries at both Johns Hopkins University and Intuitive Surgical, Inc. To date, over 40 surgical recordings have been acquired. Over a 100 training recordings have also been performed with over 30 users including trainees and experts.

We also continue to acquire task performance data using our data collection system and task boards. Recently, we have added new motion and video data from laparoscopic surgery training procedures collected at the Johns Hopkins Simulation Center to our archive. To validate unattended data collection, this data was collected over multiple sessions with no engineering team member present during the experiments. Our data collection environment also supports remote management using the underlying operating system tools.

### Analysis of System Operation During Da Vinci Procedures

We are not aware of any systematic analysis of operator performance in robotic surgery procedures, investigating factors such as the amount of operating time used only for adjusting the camera field of view. A preliminary study shows camera control to be a very frequently used mode, consuming a clinically significant amount of total operating time. System operation data was archived using the API and post-processed to obtain statistics for the number of mode changes into camera control, and the amount of time used during camera control mode. Data in Table 1 from three da Vinci prostatectomy procedures shows that it might be easily greater than 5% of the operating time. Further, field of view changes are invoked very frequently, several times every minute. Additional procedure time used to reposition the masters before or after camera control was not included here.

TABLE 1
Endoscopic camera motion during minimally invasive
surgical procedures with da Vinci surgical robots

| Measure | Procedure #1 | Procedure #2 | Procedure #3 |
|---|---|---|---|
| Surgeon Experience | Experienced | Experienced | Novice |
| Level | | | |
| Total Time | 62 min 35 sec | 74 min 2 sec | 120 min 35 sec |
| Time used for camera | 4 min 38 sec | 4 min 35 sec | 7 min 14 sec |
| control | | | |
| Num Camera Control | 560 | 542 | 558 |
| events | | | |
| Camera control per | 8.949 | 7.321 | 4.628 |
| minute | | | |
| Minimum event time | 0.238 | 0.218 | 0.194 |
| (sec) | | | |
| Maximum event time | 2.883 | 2.375 | 7.393 |
| (sec) | | | |
| Mean event time (sec) | 0.497 | 0.507 | 0.778 |
| Median event time | 0.421 | 0.464 | 0.677 |
| (sec) | | | |

These findings, which need to be validated with larger studies, indicate system operation tasks easily consume clinically significant portions of the total operating time. There are several similar system operation tasks (for example, master repositioning, and instrument exchange) that similarly contribute significantly to the total operating time. It is therefore important to understand development of system and operation skills in robotic surgery users.

### Statistical Models of Suturing Using the Da Vinci Robot

We have developed statistical models of operator motion for specific surgical tasks. To focus on the central objective of detecting and segmenting sub-tasks, we created a simplified experimental paradigm predicated on performing a suturing task with the da Vinci system by three users; the users' skill-levels were rated as “expert,” “intermediate,” and “novice.” Each user performed about 15 trials, where each trial consisted of four throws, with eight identifiable sub-tasks:

| Motion | Description |
|---|---|
| 1 | Reach for needle (gripper open) |
| 2 | position needle (holding needle) |
| 3 | Insert needle/push needle through tissue |
| 4 | Move to middle with needle (left hand) |
| 5 | Move to middle with needle (right hand) |
| 6 | Pull suture with left hand |
| 7 | Pull suture with right hand |
| 8 | Orient needle with two hands |

For each trial, the collected data consisted of 78 motion variables acquired at a 10 Hz rate from the da Vinci API. The master console's left- and right-hand manipulator motions were each tracked by 25 variables, while the left- and right-robotic instrument arms were each tracked by 14 variables. Each trial contained about 600 such motion variables, in addition to the synchronous video data.

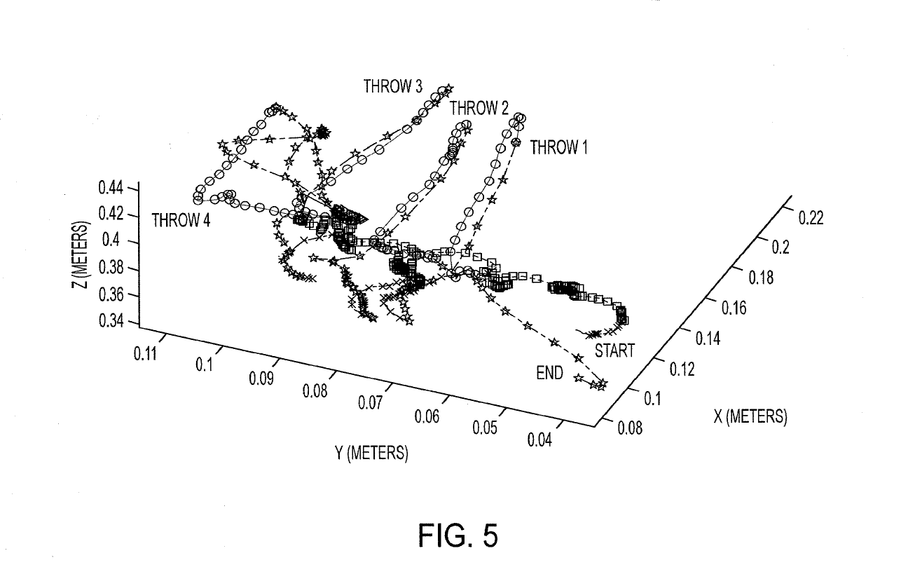

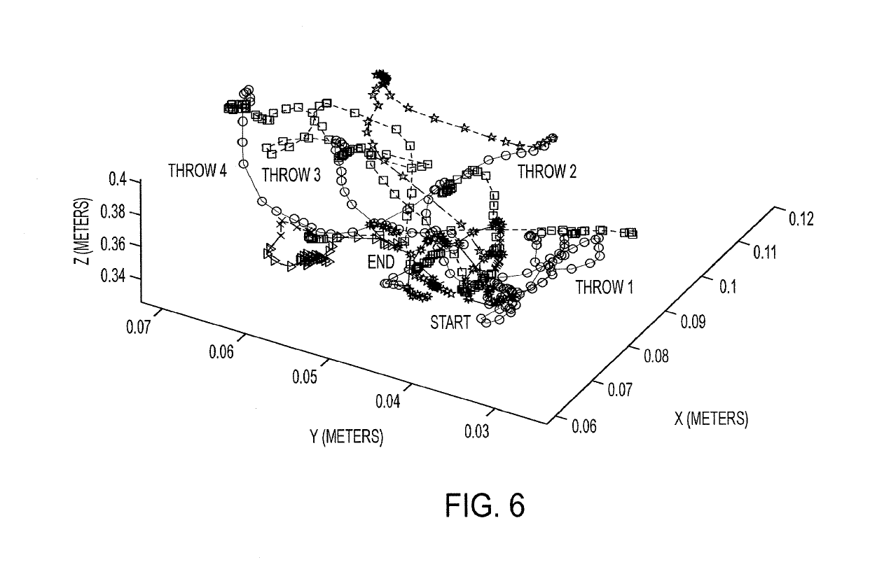

Examining the Cartesian positions of the da Vinci left-hand manipulator, the four suture throws performed by the expert user in the suturing task can be easily discerned (FIGS. 5 and 6), suggesting that an automated methods might be able to distinguish this task with good accuracy.

We designed an automatic statistical system capable of identifying the sub-task being performed in real-time using the da Vinci API. This statistical system was trained using a set of examples. To test the system, we divided the collected data into training and testing sets, where the training motion data was assimilated using machine learning techniques and recognition accuracy measured on the testing motion data. To improve the statistical significance of the results, we rotated the data that went into training and testing sets about 15 times (i.e., 15-fold cross-validation) and measured the mean accuracies.

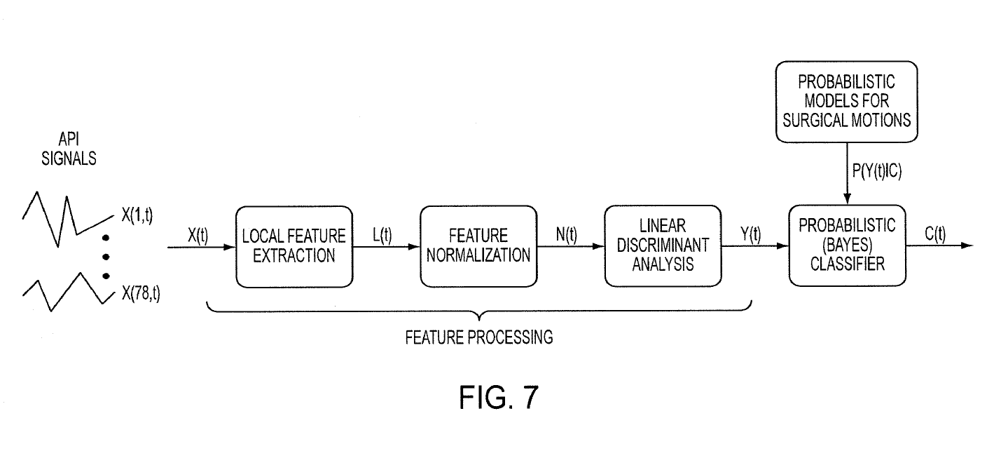

Our task recognition system (FIG. 7) can be divided into two parts: one that processes the input features, and the other that builds a classifier using these features.

The dynamic ranges of different motion parameters (i.e., position, velocity, rotation, and acceleration) are significantly different. It is well-known from the machine learning literature that these differences can adversely impact motion recognition. To account for this, these parameters were normalized to have zero mean and unit variances. Furthermore, the 78 motion control and monitor variables from the da Vinci API contain redundancies that could impair the performance of the back-end classifier. This calls for the use of a dimension reduction mechanism; and in the context of classification, Linear Discriminant Analysis (LDA) provides a reasonable solution.

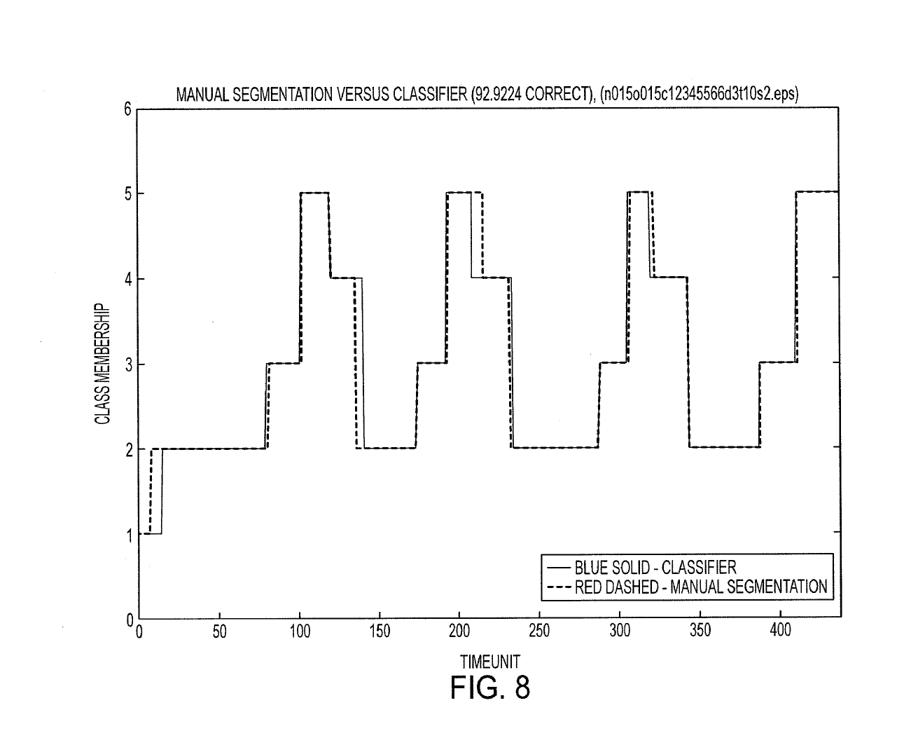

Modeling task sequences is difficult, since the number of possible sequences increases exponentially with task length. To develop task models that can be tracked, certain independence assumptions need to be made. These assumptions allow models to represent local phenomena with low variance. However, for most real-world processes, an observation at any given time is highly influenced by its context. One simple way of dealing with this is to append the observation vector at any given time with frames from its context. Here, we do this by appending each feature vector with those from its neighbors. The processed features were then entered into two different automatic detection and segmentation techniques. First, we used a simple Bayesian classifier which modeled the frames at each time instance independently using a multivariate Gaussian distribution (FIG. 8). Second, we tried an alternative approach using HMMs to model the sequential nature of the signal through a hidden state sequence.

Results and Discussion:

We found that the motion signals in our system were distinct enough to allow both Bayesian classification and HMM techniques to work equally well. Further, we found that accuracy of labeling is comparable when we use only the rigid body motion of the tools (thus making the representation of the data independent of the da Vinci kinematics). An analysis of the predicted labels showed that the errors occurred mostly at the transitions between sub-tasks. To a certain extent, this could also be attributed to small inconsistencies in human annotation; it is hard to determine precisely when a sub-task ends and the next begins when the transition occurs smoothly. Allowing a tolerance of +/−0.2 seconds, we obtained accuracy rates over 92%. We also investigated an alternative strategy using Support Vector Machines (SVMs), which have provided superior performance in a number of applications. SVMs can easily accommodate large dimensional spaces with redundant information. Therefore, we applied SVMs directly after computing the local contextual information. We found that SVMs provided an additional gain in accuracy of about 0.5%; an accuracy of about 93% was achieved.

### Automated Surgical Skill Evaluation

The sub-task segmentation of defined surgical tasks, as described above, provides a mechanism for computing a rich set of features for building an automatic surgical skill evaluation system. In an example, we examined two simple features which can be computed automatically, to understand the issues in developing such an evaluation system. This study was conducted with data collected from users at two different skill levels: 12 trials by an “intermediate” user and 15 trials by an “expert” user. An HMM was trained using the data from the expert user and was subsequently used to segment the motion data acquired from the intermediate user. Similarly, the task trials performed by the expert user were also segmented in each of the 15 trials. The trial being segmented was held-out from the training data to make certain that there was no overlap between the training and testing data. In this way, all of the surgical task trials were automatically segmented into five discrete sub-tasks, obtained by collapsing the eight sub-tasks described above (some sub-tasks with few data points were folded into others).

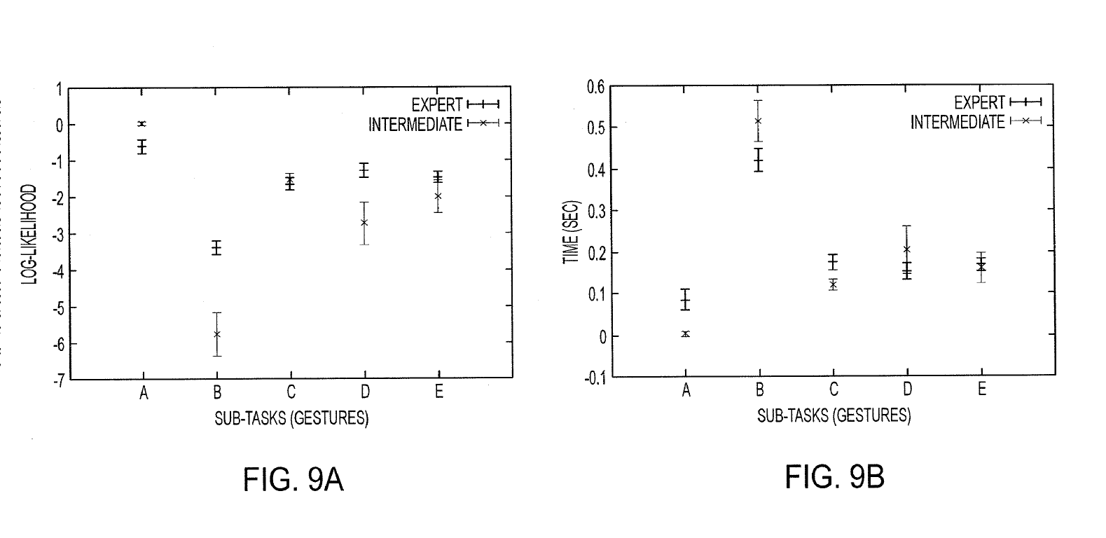

Prior studies have suggested that the amount of time spent in performing a task is a good indicator of surgical skill. This feature can be computed automatically from each task trial. Additionally, a second feature can be computed that measures how well a given performance matches the stylized “ideal” model derived from expert performances of the task. These two features were computed for the five sub-tasks and subsequently pooled for the two skill levels. The different distributions of the two features, in terms of mean and standard deviation, clearly show that these features can be used to discriminate (FIG. 9) between the two skill levels.

### Multi-User Trials

An example on surgical gesture recognition comprised 35 trials from seven subjects (Table 2) performing surgical suturing task on bench top models using phantom tissue. Validation experiments were done using da Vinci surgeons and non-surgeons on the robot-assisted system. We applied the recognition and segmentation technique of various statistical methods including Gaussian Mixture Models, 3-state Hidden Markov Models, and supervised and unsupervised Maximum Likelihood Linear Regression (MLLR) to test the robustness of the motion recognition algorithm of a variety of users. Success was defined by comparing the accuracy of the automatically labeled data with frame by frame manually labeled data. This shows an improvement using user specific models like MLLR to account for larger data sets.

TABLE 2
Gesture recognition in multi-user trials

| | | | 2-state | Supervised | Unsupervised |
|---|---|---|---|---|---|
| | LDA | GMM | HMM | MLLR | MLLR |
| Subject | (%) | (%) | (%) | (%) | (%) |
| 0 | 68.91 | 67.9 | 66.8 | 70.4 | 69.8 |
| 1 | 64.09 | 63.2 | 64.6 | 68.6 | 66.5 |
| 2 | 59.95 | 60.4 | 59.4 | 61.2 | 62.3 |
| 3 | 67.52 | 70.6 | 72.8 | 75.6 | 75.4 |
| 4 | 63.94 | 67.5 | 66.7 | 69.3 | 69.1 |
| 5 | 76.82 | 72.7 | 71.2 | 75.8 | 73.1 |
| 6 | 69.27 | 70.2 | 71.9 | 75.7 | 76.2 |
| Average | 67.21 | 67.49 | 67.62 | 70.94 | 70.34 |

Preliminary assessments of the surgical motion similarity between these bench top models and live surgery show that the recognition algorithm learned from the bench top model had on average much lower recognition rates of 20% for suturing, 21% for needle passing, and 17% for knot tying when tested against three trials of live surgical models

Analysis of Tool Tissue Interaction:

We have applied these techniques to the problem of spotting tool-tissue interaction in API data recorded during training surgeries performed on animal models. We found that we were able to recognize cases where tools interacted with ties with an overall accuracy of 76% (85% true positives, 31% false positives, (Voros, S, and Hager, G; Towards “real-Time” Tool-Tissue Interaction Detection in Robotically Assisted Laparoscopy; IEEE International Conference on Biomedical Robotics and Biomechatronics, pp. 562-567, 2008)). In as yet unpublished work, we have increased these percentages to over 90% using a nearest-neighbor classifier. These early results are very encouraging in this challenging environment.

Analysis of Suturing in daVinci Video:

We have also analyzed video data from 20 da Vinci suturing trials acquired without annotation (see Table 3). The analysis uses HMM models with 18 states, with each state representing a surgical gesture or sub-gesture. Each trial is labeled using the evolved HMM and best path for each of 20 trials through the 18 states determined. This provides a sequence of labels, where each label is a state in the HMM. Variations in suturing resulting from differences in surgical technique or expertise can then be identified by minimizing the edit distance (number of insertions, deletions, and substitutions). Alignment of frames between 2 such trials may allow expert visual comparisons of surgical technique and sub-gestures for a surgical task.

TABLE 3
Average edit distance between users of varying skill levels.

| | Expert | Intermediate | Novice |
|---|---|---|---|
| Expert | 0.38 | 0.51 | 0.61 |
| Intermediate | 0.51 | 0.42 | 0.62 |
| Novice | 0.61 | 0.62 | 0.65 |

### Multi Center Data Collection

Some embodiments of the current invention can be integrated into an automatic measurement system in this multi-center residency program providing transparent access to a larger number of robotic surgery trainees. As part of the preparation for the residency program Intuitive Surgical held a workshop of the directors of some of the leading robotic surgery training program in the United States that are also to be part of their pilot program.

### Example 2

### Introduction

Minimally-invasive cardiothoracic operations have been facilitated with new surgical robotic technologies. Although there are over 1700 surgical robotic systems in clinical use worldwide [1] by mid 2010, the application of robotics to cardiothoracic surgery has not caught up with other surgical disciplines due largely to steep learning curves in developing operational proficiency with surgical robotic platforms [2,3] coupled with comparatively lower tolerances for technical error and delay. Specifically, the technical challenges presented in performing precise and complex reconstructive techniques with limited access and the longer cardiopulmonary bypass and aortic cross clamp times associated with robot-assisted cardiac operations [2,3,4] have hampered widespread acceptance of robotics in the cardiothoracic surgical community. Improved adoption and use of robotic surgery technology will require improvements in both technology, and training methods.

The traditional Halstedian principles of surgical training using a “see one, do one, teach one” apprenticeship model are not wholly applicable to surgical robotic training. To develop clinical proficiency, effective training and practice strategies to familiarize surgeons with new robotic technologies are required [2,3]. However, current robotic training approaches lack uniform criteria for assessing and tracking technical and operational skills. Establishing standard, objective, and automated skill measures leading to effective training curricula and certification programs for robotic surgery will require: (1) a significant cohort of robotic surgeons-in-training of similar skill that can be tracked longitudinally (e.g., one year) during the acquisition of skills, (2) a set of standardized surgical tasks, (3) the ability to acquire and analyze large volumes of motion data, and (4) consistent “ground truth” assessment of the collected data by experts.

Published research in robotic surgery training has been limited to quantification of skill measures from ab initio training [5,6] of relatively short duration. Previous efforts to objectively quantify measures of skill on a limited number of trainees [7, 8] have also been predicated upon comparing trainees of varying skill levels (e.g., postgraduate year of training) with “expert” surgeons. These studies use the experimental tasks for both training, and assessment. Robotic surgical systems require complex man-machine interactions and art has also not differentiated between clinical task skills and machine operational and technical skills.

We opted to take a new approach by developing a novel automated motion recognition system capable of objectively differentiating between operational and technical robotic surgical skills and longitudinally tracking trainees during skill development. We establish multiple learning curves for each training step; provide comparative analysis of skill development, and develop methods for feedback to effectively address skill deficiencies. We also use our tasks as benchmark evaluations, not as training tasks. This is also the first longitudinal multi-center study involving robotic surgical training and comprises the largest trainee cohort to date.

### Methods

The measurement of objective performance metrics in surgical training (i.e., efficiency of hand movement) has previously required instrumented prototype devices that are not widely available, interfere with surgical technique, and employ technologies that are not commonly available or easily integrated into conventional surgical instrumentation e.g. [9]. As a novel “transparent” alternative, we have developed new infrastructure to collect motion and video data from robotic surgical training that does not require any special instrumentation and holds the promise of a training environment that does not require on-site supervision by an expert surgeon.

### Data Collection:

Our motion data collection platform uses the da Vinci surgical robotic system. Its Application Programming Interface (API [10]) provides a robust motion data set containing 334 position and motion parameters. The API automatically streams motion vectors including joint angles, Cartesian position and velocity, gripper angle, and joint velocity and torque data for the master console manipulators, stereoscopic camera, and instruments over an Ethernet connection to an encrypted archival workstation. The API also streams several system events, including instrumentation changes, manipulator “clutching”, and visual field adjustments. The API can provide faster motion data acquisition rates (up to 100 Hz) than those obtained with video recordings (typically up to 30 Hz). In addition, high-quality time-synchronized video can be acquired from the stereoscopic video system. Using the data collection framework (FIG. 1, left) 334 system variables were sampled at 50 Hz and stereoscopic video streams collected at 30 Hz. This data was anonymized at source, assigned a unique subject identifier, and archived in a database according to an approved IRB protocol. For analysis, the archived data was further segmented into task or system operation sequences. This process generated 20-25 GB of data per hour. No special training was required to operate the archival workstation, which can be left connected in place, without impacting surgical or other training use.

Experimental Tasks: Training data was collected in all stages of training. Our training protocol was divided into different training modules:

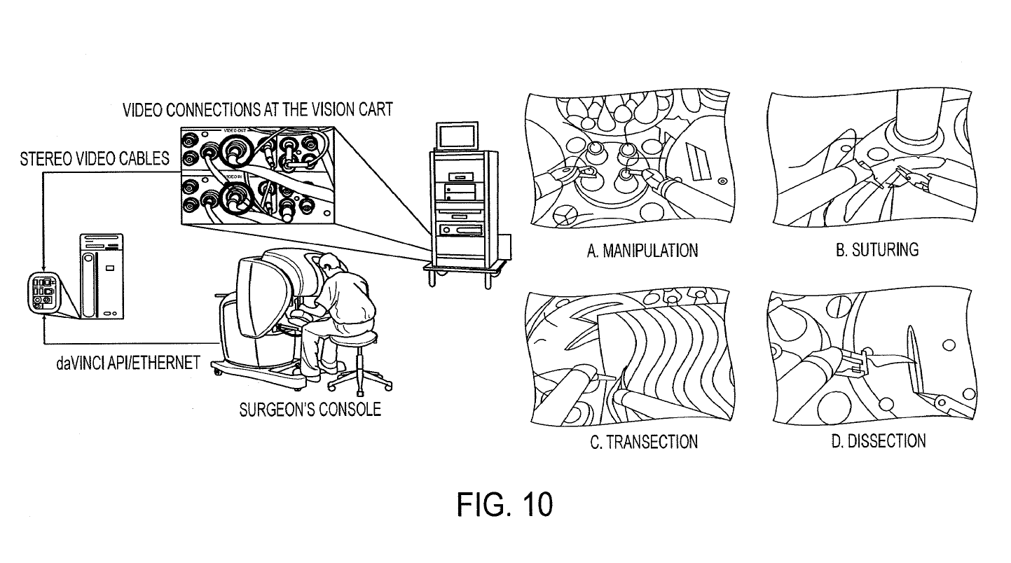

Module I: System Orientation Skills: This training module is intended to familiarize the trainee with basic system and surgical skills, including master console clutching, camera control, manipulation scale change, retraction, suturing, tissue handling, bimanual manipulation, transaction, and dissection. Trainees already practice these basic skills in current training regimes and they are appropriate for benchmarking. On a monthly basis, we collected data from periodic benchmarking executions of four minimally invasive surgical skills taken from the Intuitive Surgical robotic surgery training practicum [11]. These tasks (FIG. 10, right) are:
Manipulation: This task tests the subject's system operation skills. It requires transfer of four rings from the center pegs of the task pod to the corresponding outer peg, followed by replacement of the rings to the inner pegs in sequence. Elementary task performance measures include task completion times and task errors (e.g., dropped ring/peg, moving instruments outside of field of view).
Suturing: This task involves the repair of a linear defect with three 10 cm lengths of 3-0 Vicryl suture. Elementary task performance measures include task completion times and task errors (e.g., dropped needles, broken sutures, inaccurate approximation).
Transection: This task involves cutting an “S” or circle pattern on a transection pod using curved scissors while stabilizing the pod with the third arm. Elementary task performance measures include task completion times and task errors (e.g., cutting outside of the pattern).
Dissection: The dissection task requires dissection of a superficial layer of the pod to gain exposure to a buried vessel, followed by circumferential dissection to fully mobilize the vessel. Task completion times and errors (e.g., damage to the vessel, incomplete mobilization, and excessive dissection) are measured.

These orientation laboratories typically produced an hour of training data. Upon successful acquisition of these basic skills, trainees were graduated to the second module below. This work highlights analysis of the first training module.

Module II: Minimally-Invasive Surgical Skills: This module is intended to familiarize the trainee with basic minimally invasive surgical (MIS) skills, including port placement, instrument exchange, complex manipulation, and resolution of instrument collisions.

Graduation between modules is based on the trainees reaching expert skill levels, or upon completion of six months. We aim to continue to track our trainees to proficiency wherever they practice limited only by access to their robotic systems for data collection.

### Recruitment and Status

30 robotic surgical users (of a goal of 48) from three academic surgical training programs (Johns Hopkins, Boston Children's, U. Penn and Stanford) have been recruited to participate in our ongoing study. Additional training centers and subjects are being added as approval is received from IRBs and their training robots are activated for data collection by the manufacturer of the robotic system (Intuitive Surgical, Inc.). Our subjects were stratified according to four skill levels: novice, beginner, intermediate, and expert. Novice trainees were defined as having no prior experience with the da Vinci robotic system. Beginner trainees possessed only limited dry-lab experience and no clinical experience with the da Vinci system. Intermediate trainees possessed limited clinical experience with the robotic system. Expert users were comprised of faculty surgeons with clinical robotic surgical practices. Performance data from each subject was collected at monthly intervals throughout their training period. Expert surgeons provided two executions of the training tasks to establish skill metrics. Here we analyze 4 expert users, and 8 other users of non-expert skill levels.

### Structured Assessment

To validate our framework's construct, we applied Objective Structured Assessment of Technical Skills (OSATS) [12, 13] evaluations for each task execution. The OSATS global rating scale consists of six skill-related variables in operative procedures that were graded on a five point Likert-like scale (i.e., 1 to 5). The middle and extreme points are explicitly defined. The six measured categories are: (1) Respect for Tissue (R), (2) Time & Motion (TM), Instrument Handling (H), Knowledge of Instruments (K), Flow of procedure (F), and Knowledge of procedure (KP). The “Use of Assistants” category is not generally applicable in the first training module, and was therefore not evaluated. A cumulative score totally individual scores for each of the six categories is obtained (minimum score=0, maximum score=30). OSATS evaluation construct has been previously validated in terms of inter-rater variability and correlation with technical maturity [13, 14] and has been applied in evaluating facility with robot-assisted surgery [15].

### Automated Measures

There are at least two different types of automated measures that can be computed from the longitudinal data we have acquired. The first are aggregated motion statistics, task measures, and associated longitudinal assessments (i.e., learning curves). The second include measures computed using statistical analysis for comparing technical skills of trainees to that of expert surgeons.

Motion Statistics and Task Measures:

Table 2.1 shows the computed elementary measures for the defined surgical task executions. Each of these measures is used to derive an associated learning curve over the longitudinally collected data.

TABLE 2.1
Aggregate measures computed from longitudinal data:
Experts performed each task twice to reduce
variability-sample task times (seconds, top), master
handle motion distances (meters. middle), and
number of camera foot pedal events (counts, bottom)
are detailed for the training tasks in the first module.

| | | Session | Session | Session | Session | Session |
|---|---|---|---|---|---|---|
| | Task | 1 | 2 | 3 | 4 | 5 |
| Task | | | | | | |
| times(sec) | | | | | | |
| Expert | Suturing | 348 | 322 | | | |
| | Manipulation | 238 | 238 | | | |
| | Transection | 133 | 149 | | | |
| | Dissection | 188 | 260 | | | |
| Trainee | Suturing | 454 | 588 | 255 | 289 | 279 |
| | Manipulation | 867 | 577 | 311 | 282 | 442 |
| | Transection | 107 | 196 | 76 | 103 | 126 |
| | Dissection | 363 | 291 | 191 | 492 | 200 |
| Motion | | | | | | |
| (m) | | | | | | |
| Expert | Suturing | 13.0 | 10.3 | | | |
| | Manipulation | 14.9 | 14.2 | | | |
| | Transection | 1.8 | 1.2 | | | |
| | Dissection | 3.2 | 6.6 | | | |
| Trainee | Suturing | 12.9 | 15.0 | 6.1 | 6.1 | 6.8 |
| | Manipulation | 27.8 | 17.8 | 15.1 | 16.5 | 21.1 |
| | Transection | 1.7 | 1.6 | 0.5 | 1.1 | 1.1 |
| | Dissection | 8.1 | 5.0 | 4.0 | 9.3 | 3.4 |
| Events | | | | | | |
| (count) | | | | | | |
| Expert | Suturing | 8 | 2 | | | |
| | Manipulation | 43 | 40 | | | |
| | Transection | 3 | 2 | | | |
| | Dissection | 0 | 2 | | | |
| Trainee | Suturing | 0 | 0 | 2 | 6 | 4 |
| | Manipulation | 98 | 61 | 61 | 50 | 89 |
| | Transection | 1 | 1 | 1 | 5 | 3 |
| | Dissection | 5 | 7 | 4 | 7 | 5 |

Statistical Classification of Technical Skill:

Our group and collaborators [16, 17, 18, 19] have previously used the da Vinci API motion data to develop statistical methodologies for the automatic segmentation and analysis of basic surgical motions for quantitative assessment of surgical skills. Lin et al [16] used linear discriminant analysis (LDA), to reduce the motion parameters to three or four dimensions, and Bayesian classification to detect and segment basic surgical motions, termed “gestures”. Reiley et al [19] used a Hidden Markov Model (HMM) approach for modeling gestures. These studies report that experienced surgeons perform surgical tasks significantly faster, more consistently, more efficiently, and with lower error rates [19,20]. We summarize assessment of robotic system operational skills by using Support Vector machines (SVM) to cluster dimensionally reduced data, revealing different levels of competence. A SVM transforms the input data into a higher dimensional space using a kernel function, and an optimization step then estimates hyperplanes separating the data with maximum separation.

### Results

Structured Assessment:

Table 2.1 shows a clear separation between trainees based on their system operational skills and clinical background, providing a validated “ground truth” for assessing our automated methods.

Workspace Management:

Maintaining a compact operative workspace is an important robotic system operation skill. Expert robotic surgeons maintain an optimum field of view for a given operative task, keeping the instruments within the field of view at all times (FIG. 11, bottom left) while trainees tend to zoom out to a broad field of view that is not adjusted during the task performance (FIG. 11, bottom right).

FIG. 11 (top) graphically illustrates the differences in workspace usage between trainees and expert robotic surgeons performing the manipulation task. The trajectories represent master handle motion, and the enclosing volumes represent total volumes used, and the volume enclosed by the positions of the master handles at the end of master clutch adjustment. The workspace usage evolves to become closer to the expert workspace usage as trainees learn to adjust their workspaces more efficiently. Expert task executions also include regularly spaced camera clutch events to maintain the instruments in the field of view.

We use master handle motion for computations here, as compared to instrument tip motion reported in the literature since it better measures the operational skill by capturing all the master motion required to adjust the master workspace, which is not captured by instrument tip motion. We measure both the master distance, as well as the volume in which the master handles were moved. Although not reported here, we do also measure and analyze instrument motion statistics, as well as counts of other foot pedals, instrument exchanges, and other system events.

Learning Curves:

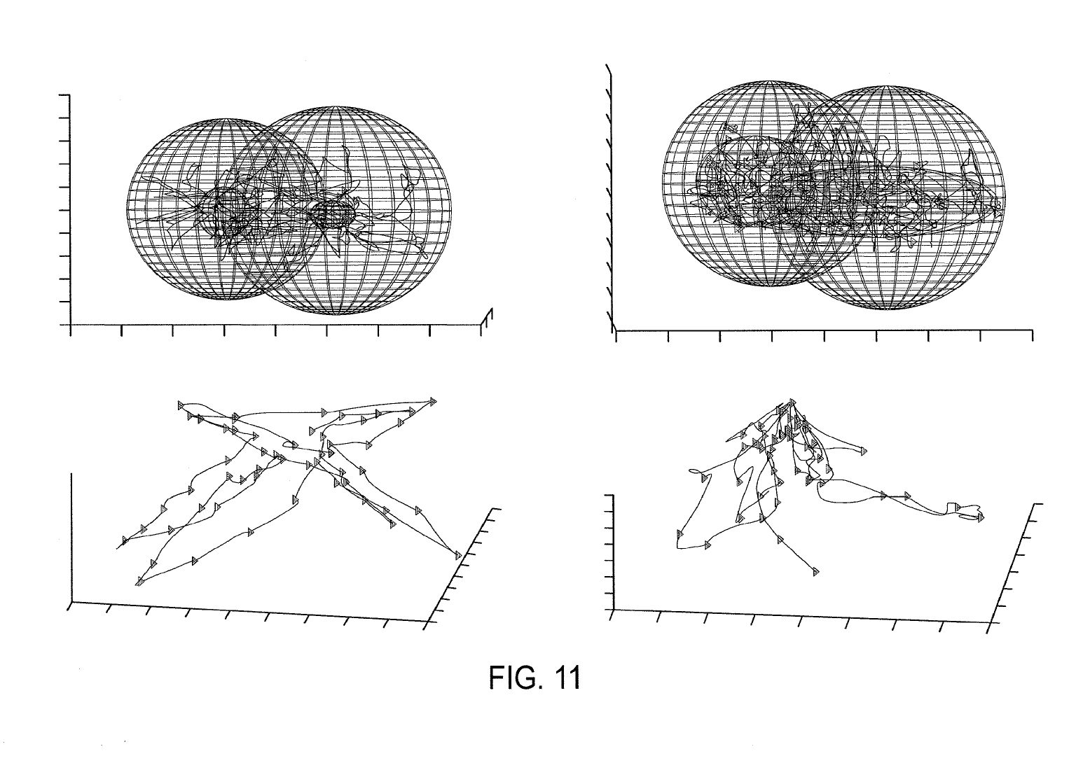

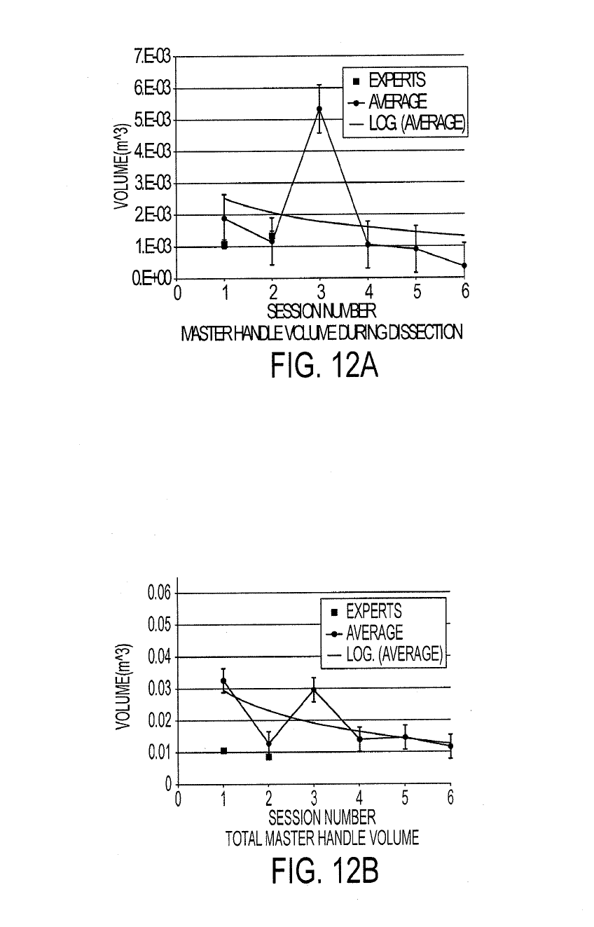

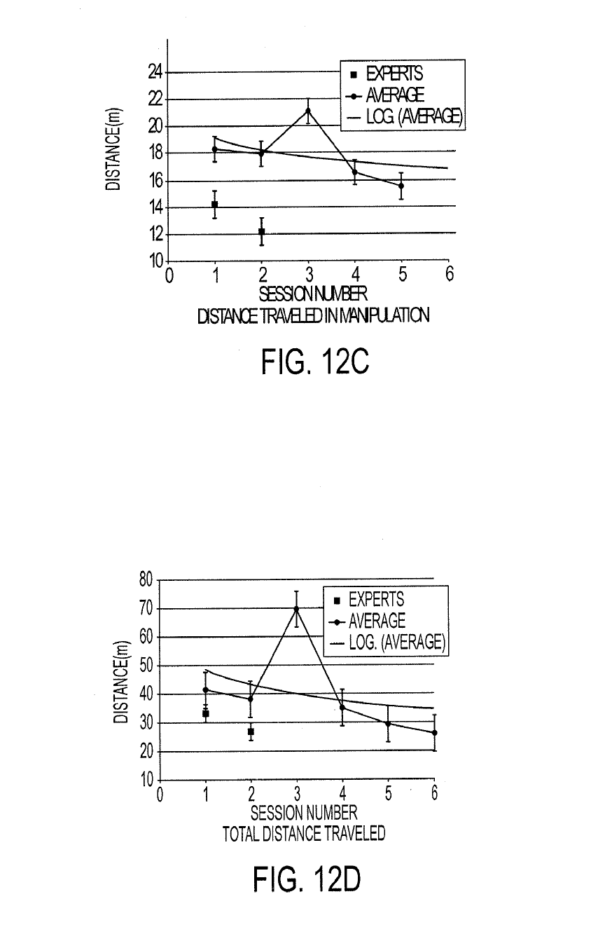

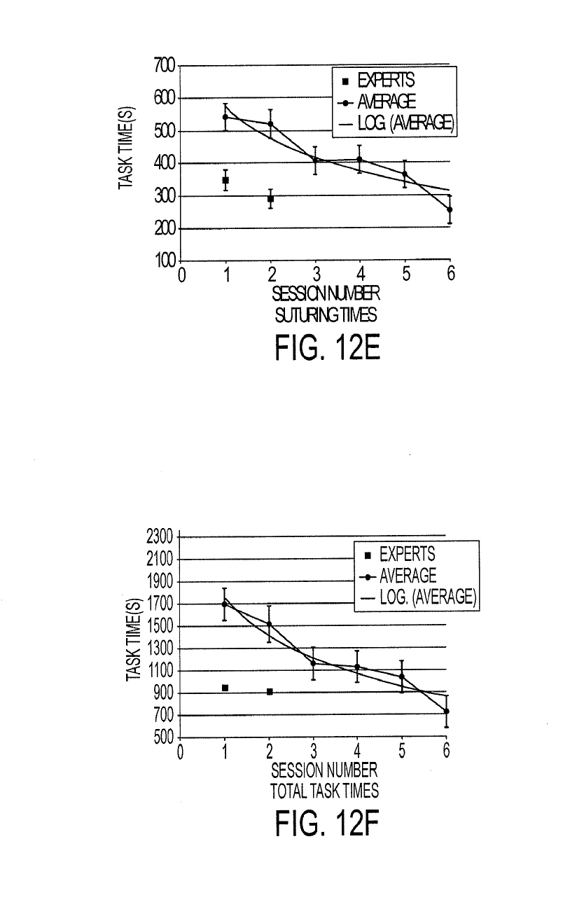

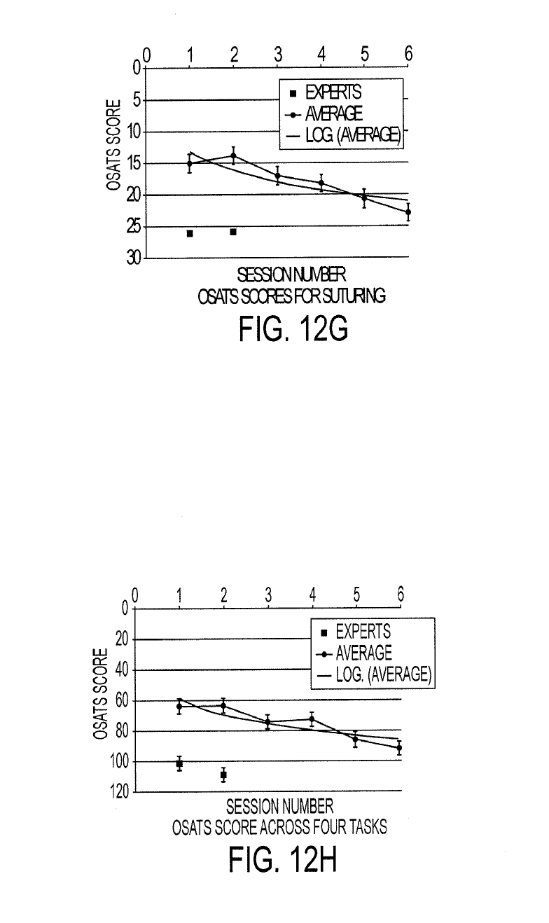

FIGS. 12a-12h show learning curves derived from task motion and times required to complete the defined surgical tasks and the corresponding learning curves based on the corresponding expert OSATS structured assessments. ANOVA (F=71.88>2.23, F=51.02>2.37, and F=71.4>2.57 at α=0.05 at 1, 3 and 5 months) results are significant at 5% significance level indicating that the expected values for time, OSATS, master motion, and master volumes differ significantly. Trainee performance improves with time as indicated by smaller task completion time, smaller volumes, shorter motion, and correlated improved in OSATS scores. By comparison, expert measures had very small variability in the two executions.

The computed measures (e.g. task times, total time, master motion, and master volume) at 1, 3 and 5 month intervals correlate with OSATS scores for the corresponding sessions (p<0.05). For suturing, at month 1, the mean OSATS (M=77.58, V=527.35, N=12), and suturing time (M=466.29, V=39392.63, N=12) was significantly greater than zero, with t(11)=−6.27, two-tail p=6.07E-5, providing evidence that task completion time correlates with ground truth assessment. Table 2.2 details the p-values for alpha=0.05.

Table 2.2: Two-tail p-vlaues (top) for pair-wise t-tests at 1, 3, and 5 months time intervals, and (alpha=0.05) for OSATS scores and suturing time (suturing), total time (time), manipulation distance (manip), total task distance (distance), master handle volume in dissection (dissec), and total master handle volume (volume). P-values for one-factor analysis of variation (ANOVA) for all variables (bottom) at the same intervals.

| PAIRWISE | | OSATS/ | OSATS/ | OSATS/ | OSATS/ | OSATS/ | OSATS/ |
|---|---|---|---|---|---|---|---|
| t-TEST | N | suturing | time | manipulation | distance | dissection | volume |
| 1 | 12 | 6E−5 | 2.8E−5 | 9.9E−4 (N = 8) | 0.0014 | 1.5E−7 | 1.5E−7 |
| 3 | 6 | 0.0016 | 1.4E−4 | 0.0067 | 0.9303 | 8.4E−5 | 8.5E−5 |
| 5 | 3 | 0.0227 | 2.3E−4 | 0.0052 | 0.0043 | 8.4E−4 | 8.4E−4 |

| ANOVA | N | P-value | F | F-critical |
|---|---|---|---|---|
| 1 | 12 | 8.4E−24 | 47.7 | 2.22 |
| 3 | 6 | 7.8E−20 | 90.5 | 2.37 |
| 5 | 3 | 2.5E−15 | 472.1 | 2.85 |

Skill Assessment:

For a portion of the dataset (2 experts, 4 non-experts) we clustered the motion data, first using principal component analysis (PCA) to reduce data dimensions for Cartesian instrument velocities signals. We then trained a binary support vector machine (SVM) classifier on a portion of the data, and used the trained classifier to perform expert vs. rest binary classification. This methodology correctly stratified our subjects according to their respective skill levels with 83.33% accuracy for the suturing task, and 76.25% accuracy for the manipulation task. Detailed automated analysis on this and expanded datasets is being reported separately.

### Discussion

Clinical skill measures should be a measure of the instrument-environment interaction. While instrument motion is measured accurately using the sensors built into the robots, the interaction and effects of tools with the environment (the patient or model), and additional tools such as needles and sutures is not captured in the kinematic motion data. In comparison to art, where the instrument motion has been primarily used as an indicator of “clinical” skill, we focus on “operational” skills for robotic surgery systems. Robotic surgery uses a complex man-machine interface, and it is the complexity of this interface that creates long learning curves even for laparoscopically trained surgeons.

We describe a longitudinal study of robotic surgery trainees, including preliminary assessment of both structured expert assessment (OSATS), as well as automatically computed statistics and measure of skills. Operational skill effects can be completely captured using the telemetry available from the robotic system, and with appropriate tasks and measures, separate learning curves can be identified. In particular we note very high agreement between structured assessment of task performance using OSATS and master workspace measures (distance, volume, time) computed above. Additional measures computed, but not described here, include camera motion effects, instrument motion measures similar to the literature, learning curves based on system events, and learning curves based on abnormal events, and reactions to abnormal events.

We perform longitudinal analysis to develop learning curves. This is an essential exercise towards development of both training curricula, and metrics that are discriminative of operational skill. As noted the measures of skill based on master manipulation show large differences between experts and non-experts and convergence towards the experts as training progresses. Ab initio training, where operational skills and system orientation are most important, is only the first step in robotic surgery training. Additional modules of training upon completion of the first module add port constraints, instrument collisions, and more complex tasks.

This analysis presented here uses only a portion of our data, and discusses only some of the measures computed. Additional larger studies involving larger datasets and alternative methods are currently underway. In ongoing work, we are also measuring response times to errors, and their development curves as additional skill measures. Finally, relatively simple statistical classification is reported here, with accuracies of greater than 80%, only to highlight the quality of our data. In ongoing work, we are also using alternative supervised and unsupervised multi-class classification both for operation skills, as well as surgical task skills.

### REFERENCES FOR EXAMPLE 2

1. Intuitive Surgical Inc, http://www.intuitivesurgical.com/products/faq/index.aspx, 2010.
2. Novick R J, Fox S A, Kiaii B B, Stitt L W, Rayman R, Kodera K, et al. Analysis of the learning curve in telerobotic, beating heart coronary artery bypass grafting: a 90 patient experience. The Annals of thoracic surgery 2003; 76(3):749-753
3. Rodriguez E and Chitwood Jr W R. Outcomes in robotic cardiac surgery, Journal of Robotic Surgery, 2007; 1:19-23
4. Chitwood Jr, W R. Current status of endoscopic and robotic mitral valve surgery. The Annals of thoracic surgery 2005; 79(6):S2248-S2253
5. Ro C Y, Toumpoulis I K, Jr R C A, Imielinska C, Jebara T, Shin S H, et al. A novel drill set for the enhancement and assessment of robotic surgical performance. Studies in Health Technology and Informatics, Proc. Medicine Meeting Virtual Reality (MMVR). 2005; 111:418-421
6. Judkins T N, Oleynikov D, Stergiou N. Objective evaluation of expert and novice performance during robotic surgical training tasks. Surgical Endoscopy 2009; 23(3):590-597
7. Sarle R, Tewari A, Shrivastava A, Peabody J and Menon M. Surgical robotics and laparoscopic training drills. Journal of Endourology. 2004; 18(1):63-67
8. Narazaki K, Oleynikov D, and Stergiou N. Objective assessment of proficiency with bimanual inanimate tasks in robotic laparoscopy. Journal of Laparoendoscopic & Advanced Surgical Techniques. 2007; 17(1):47-52
9. Datta V, Mackay S, Mandalia M, and Darzi A. The use of electromagnetic motion tracking analysis to objectively measure open surgical skill in the laboratory-based model. Journal of the American College of Surgeons. 2001; 193(5):479-485
10. DiMaio S, and Hasser C. The da Vinci Research Interface, Systems and Architectures for Computer Assisted Interventions workshop (MICCAI 2008), http://www.midasiournal.org/browse/publication/622, 2008.
11. Mohr C, and Curet M, The Intuitive Surgical System Skill Practicum. Intuitive Surgical, Inc, 2008
12. Martin J A, Regehr G, Reznick R, MacRae H, Murnaghan J, Hutchison C, et al. Objective structured assessment of technical skill (OSATS) for surgical residents. British Journal of Surgery. 1997; 84(2):273-278
13. Faulkner H, Regehr G, Martin J, Reznick R. Validation of an objective structured assessment of technical skill for surgical residents. Academic Medicine. 1996; 71(12):1363
14. Darzi A, Smith S, and Taffinder N. Assessing operative skill. British Medical Journal. 1999; 318(7188):887
15. Hernandez J D, Bann S D, Munz Y, Moorthy K, Datta V, Martin S, et al. Qualitative and quantitative analysis of the learning curve of a simulated surgical task on the da Vinci system. Surgical Endoscopy. 2004; 18:372-378
16. Lin H C, Shafran I, Yuh D, Hager G D. Towards automatic skill evaluation: Detection and segmentation of robot-assisted surgical motions. Computer Aided Surgery. 2006; 11(5):220-230
17. Verner L, Oleynikov D, Hotmann S, Zhukov L. Measurements of level of surgical expertise using flight path analysis from Da Vinci robotic surgical system. Studies in Health Technology and Informatics 2003; 94:373-378
18. Gallagher A G, Ritter E M, Satava R M, Fundamental principles of validation, and reliability: rigorous science for the assessment of surgical education and training, Surgical Endoscopy. 2003; 17:1525-1529
19. Reiley C E, Hager G D. Task versus Subtask Surgical Skill Evaluation of Robotic Minimally Invasive Surgery, Proc. Medical Image Computing and Computer-Assisted Intervention (MICCAI). 2009; 435-442
20. Gallagher A G, Richie K, McClure N, and McGuigan J. Objective psychomotor skills assessment of experienced, junior, and novice laparoscopists with virtual reality. World Journal of Surgery, 2001; 25(11):1478-1483

### Example 3

Minimally invasive surgery has seen a rapid transformation over the last two decades with the introduction and approval of robotic surgery systems [1,2]. Continued advancement in tools and techniques has established minimally invasive surgery as a standard of care in many areas of surgical practice including abdominal [4], urologic [5], otolaryngologic [6], and neurologic surgery [7], as well as cardiothoracic [3] surgery.

The increasing use of minimally invasive techniques has been motivated by reduced pain and trauma, reduced blood loss, and shorter recovery times. Successes in minimally invasive cardiac surgery have lagged behind those achieved with robotic laparoscopic surgery in other specialties due to organ motion, the physical constraints of the chest cavity, the consequences of surgical errors or excessive delay [8], as well as limited mitigations available for a failure of the robotic device.

The da Vinci surgical system (Intuitive Surgical, Sunnyvale, Calif.) was initially developed for minimally invasive cardiothoracic surgery. The robot, now in its third generation, consists of three components: a surgeon console, a patient side cart consisting of up to three robotic instrument manipulators and a robotic endoscope, and a vision cart housing the endoscopic components and in the latest generation a computation engine. The surgeon sits at the console and manipulates the master instrument handles, and the motions are scaled and transformed into appropriate instrument motions. The robot instruments at the tips contain greater precision and dexterity than human hands, and also reverse the motion inversion inherent in laparoscopy around the access ports.

The da Vinci system is now the standard of care in complex urological procedures. It has been used successfully to perform a growing number of cardiothoracic surgeries [4] including coronary artery bypass grafting [9], atrial septal defect closure [10], transmyocardial laser revascularization [11], and mitral valve repairs [12]. Training remains one of the major challenges in improving the adoption of robotic cardiothoracic surgery. The latest generation of the robotic system (the Si) can have up to two surgeon's consoles. It is based on a prototype created by one of the authors (Kumar et al, Multi-user medical robotic system for collaboration or training in minimally invasive surgical procedures, 2006), and is aimed to address the training limitations of the previous generations.

Surgical training in academic medical centers remains predicated upon the Halstedian “see one, do one, teach one” scheme in which interns and junior residents are allowed to perform operations under the tutelage of a faculty surgeon. A mentor typically adjusts the trainee's participation based on his subjective confidence in the trainee's abilities and their understanding of the procedure. We have developed methods for acquisition of detailed performance data, and objective measures of skill, that can allow greater understanding of a trainee's performance, and have the potential of greatly improving the efficiency of the training process for both the mentor and the trainee.

### Materials and Methods

We record all motion generated during a robotic surgery or training procedure in an unhindered manner. Such recording previously needed devices could not be easily incorporated into the surgical and training infrastructure [9] without impacting surgical or training workflow. By comparison, the Application Programming Interface (API [10]) in the da Vinci system permits the recording of instrument and hand motion and video data without any modification of the procedure workflow, and using our system, without on-site supervision.

Data Collection System:

Our data collection system (FIG. 1) is designed to collect data primarily from the da Vinci surgical robotic system. The API streams 334 variables at rates of up to 100 Hz containing Cartesian position and velocity, joint angles, joint velocities, torque data, and events for all robotic arms and the console buttons and foot pedals. This data is streamed over and Ethernet connection to a small portable workstation where it is encrypted and archived. Along with this data; we also record high quality synchronized video from the stereoscopic camera at real-time frame rates (30 Hz).

This data is anonymized at the source, and stored in an archive according to a Johns Hopkins Institutional Review Board protocol. Subjects are assigned unique identifiers to permit longitudinal analysis, such as computation of learning curves. This process creates 20-25 Gigabytes (GB) of data per hour. The archiving workstation does not need any special training to operate and can be left connected without affecting the system operation.

Experimental Tasks:

Our ongoing protocol is aimed at assessing robotic surgery training skills. It contains a set of minimally invasive surgery training tasks. The first module of training (FIG. 4) contains a manipulation task for system orientation, and benchmarking tests of suturing, transection, and dissection skills performed approximately monthly on training pods (The Chamberlain Group, Inc.) commonly used for robotic surgery training [11].

The manipulation task involves moving rubber rings around the entire robotic workspace. Subjects also perform interrupted suturing (3 sutures) along an I-defect using 8-10 cm length of Vicryl 3-0 suture, transect a pattern on a transection pod using the curved scissors, and mobilize an artificial vessel buried in a gel phantom using blunt dissection.

In addition to the motion data, we also record the trainee's practice hours between these benchmarking sessions. Subjects are graduated after completing six benchmarking sessions (approximately six month), or when performance measures indicate task proficiency.

Recruitment and Status:

Our subjects are robotic surgery residents and fellows from four institutions—Johns Hopkins, Children's Hospital, Boston, Stanford/VA Hospitals, and University of Pennsylvania. Practicing clinicians are recruited to provide ground truth data for computing proficiency levels of performance measures. Current recruitment stands at 24 including 6 experts.

Expert Assessment:

Expert surgeon collaborators provide an Objective Structured Assessment of Technical Skills (OSATS) [12, 13] assessment of each recorded trial. OSATS rating system has been validated in terms of inter-rater variability and correlation with technical abilities [13, 14] in robotic surgery as well [15]. The OSATS rating scale contains task performance measures rated on a five point Likert-like scale (i.e. 1 to 5). We use six categories: 1) Respect for Tissue (R), 2) Time & Motion (TM), 3) Instrument Handling (H), 4) Knowledge of Instruments (K), 5) Flow of procedure (F), and 6) Knowledge of procedure (KP). The ‘Use of Assistants’ category was not applicable in the first module and was not included in the scoring. A total score (minimum=5, maximum=30) was calculated from the individual categories.

To understand the complexity of our data and initiate analysis, we first collected data from two experts, two beginners, and two users with no clinical experience. The non-clinical users were included in this experiment only to assess the utility of clinical background in the training tasks. Table 3.2 shows the OSATS scores for the six subjects participating in this experiment.

TABLE 3.2
The OSATS scores for the 6 users

| Subjects | Task | R | TM | H | K | F | KP | Total |
|---|---|---|---|---|---|---|---|---|
| Expert1 | Manipulation | 5 | 4 | 4 | 3 | 4 | 3 | 23 |
| | Suturing | 3 | 1 | 1 | 4 | 2 | 3 | 14 |
| Expert2 | Manipulation | 3 | 3 | 3 | 3 | 3 | 3 | 18 |
| | Suturing | 3 | 2 | 1 | 3 | 2 | 2 | 13 |
| Beginner1 | Manipulation | 2 | 1 | 1 | 2 | 1 | 2 | 9 |
| | Suturing | 1 | 1 | 1 | 1 | 1 | 1 | 6 |
| Beginner2 | Manipulation | 2 | 2 | 1 | 2 | 1 | 2 | 10 |
| | Suturing | 1 | 1 | 1 | 1 | 1 | 2 | 7 |
| Non-clinical1 | Manipulation | 1 | 1 | 1 | 1 | 1 | 1 | 6 |
| | Suturing | 1 | 1 | 1 | 1 | 1 | 1 | 6 |
| Non-clinical2 | Manipulation | 2 | 1 | 1 | 2 | 1 | 2 | 9 |
| | Suturing | 2 | 1 | 1 | 2 | 1 | 2 | 9 |

Automated Assessment:

We investigated two methods of performing automated assessment—aggregated motion statistics and task performance measures, differentiating experts and non-experts, in addition to the manual structured expert assessment. Previous studies [6, 8] have used preliminary measures to identify skill with an emphasis only on comparing users of different skill levels to the experts. Table 3.1 shows elementary task performance measures like the task completion times, number of camera events, number of clutch pedal events to adjust the workspace, total distance traveled by the instruments, and the total motion of the camera.

TABLE 3.1
Average aggregate measures computed from two sessions: task
completion times (seconds, first column), number camera pedal
events, number of clutch foot pedal events, distance travelled by
patient-side instruments (meters), distance travelled by the
camera (meters) are detailed for the training tasks in the first module.

| | | Time | Camera | Clutch | PSM | Cam |
|---|---|---|---|---|---|---|
| Subjects | Task | (sec) | events | events | (m) | (m) |
| Expert1 | Manipulation | 259 | 75 | 5 | 7.1 | 1.16 |
| | Suturing | 290 | 5 | 10 | 2.4 | 0.017 |
| Expert2 | Manipulation | 250 | 88 | 2 | 7.0 | 1.33 |
| | Suturing | 202 | 8 | 8 | 2.5 | 0.19 |
| Beginner1 | Manipulation | 912 | 112 | 28 | 6.6 | 0.36 |
| | Suturing | 914 | 2 | 40 | 6.4 | 0.22 |
| Beginner2 | Manipulation | 405 | 43 | 26 | 7.7 | 0.85 |
| | Suturing | 377 | 19 | 15 | 4.4 | 0.28 |
| Non-clinical1 | Manipulation | 499 | 95 | 46 | 9.0 | 0.91 |
| | Suturing | 404 | 0 | 12 | 3.9 | 0 |
| Non-clinical2 | Manipulation | 368 | 61 | 28 | 9.7 | 0.72 |
| | Suturing | 612 | 1 | 19 | 4.6 | 0.04 |

The motion data from the da Vinci API has also been previously used to classify skill using statistical machine learning methods. These studies [16, 19] have primarily focused on recognizing the surgical task being performed. The motion data from the API is a high dimensional (334 dimensions at up to 100 Hz), and we used dimensionality reduction (Principal Component Analysis (PCA)) to project the data into a lower number of dimensions. PCA uses an orthogonal linear transformation to transform data consisting of correlated variables into a lower dimensional data consisting of uncorrelated variables to discard redundant data.

The reduced data is classified into expert and non-expert classes using Support Vector Machines (SVM). A SVM uses a kernel function and an optimization algorithm to finds a hyper-plane with optimum separation between the two classes. SVMs have been previously used to classify surgical skill in motion data as well. Given ground truth labeling, sensitivity and accuracy of the classifier can be directly computed as performance measures.

### Results

To develop our methods, we analyzed data from two experts, two beginners and two users with no clinical experience. Table 3.2 shows the scores for all the six subjects participating in our experiment. The non-clinical users were included to assess the utility of clinical background in our training tasks.

Structured Assessment:

Table 3.2 shows a clear separation between trainees based on their system operational skills and clinical background. For this small dataset, the ratings also correlate with self-reported expertise and provide us with a “ground truth” for our automated methods. Experts (OSATS score >13) are trainees (OSATS score <10) are well separated in structured assessment.

Workspace Visualization:

FIG. 11 (top left), depicts the expert master handle workspace usage for the manipulation task. The blue and red motion trajectories denote the left and right master handles respectively. The green triangles are the time points when the clutch pedal was pressed to adjust the master handles. The inner red ellipsoid shows the volume where the subject's hands returned after workspace adjustment, while the outer ellipsoid circumscribes the task work volume. FIG. 11 (top right), shows the workspace usage of a beginner for the same task. It is visually evident that the expert has a much more compact volume of work than the beginner. As training progresses, the workspace usage efficiency improves to match that of the experts.

TABLE 3.3
Longitudinal observations of time and instrument
motion distance of 2 trainees over four sessions.
Time is in seconds, distance in meters.

| | | Session 1 | | Session 2 | | Session 3 | | Session 4 | |
|---|---|---|---|---|---|---|---|---|---|
| | Tasks | Time | Dist | Time | Dist | Time | Dist | Time | Dist. |
| User | Suturing | 416 | 4.82 | 444 | 5.54 | 331 | 2.64 | 215 | 2.00 |
| 1 | Manip. | 1061 | 12.49 | 566 | 9.17 | 295 | 7.22 | 346 | 7.41 |
| User | Suturing | 1154 | 8.72 | 675 | 4.07 | 414 | 1.91 | 358 | 1.77 |
| 2 | Manip | 1289 | 12.79 | 535 | 6.55 | 444 | 5.64 | 444 | 6.97 |

FIG. 11 (bottom left) depicts expert camera motion for the same task. To maintain instruments in the field of view, the triangles represent the start and end of camera motions. To maintain the instruments in the field of view at all times, experts practice regular camera motions while maintaining approximately the same scale. A trainee (FIG. 11, bottom right) instead aims to minimize camera motion by zooming out, and moving the camera more frequently, but in small motions. These visualizations may be used to recommend specific task strategies and improvements to the trainees.

### Skill Assessment Using Statistical Classification:

Compared to trainees, experts used 74.64% more videoscopic camera motion in achieving optimum fields of view, leading to less clutching, translational motion (suturing experts<2.5 m,novices>4.4 m), collisions, and shorter task completion times (experts <290 sec, novices>375 sec).

For statistical skill classification in suturing, we segment the 3 sutures per trial (2 sessions per user) individually. This provides a total of 36 trials of which 12 are labeled expert and 24 are non-expert. We now use Cartesian velocity data for each of the suture as a feature vector. Each suture trial is approximately 5000 samples. Using principal component analysis we reduced this data to 30 dimensions.

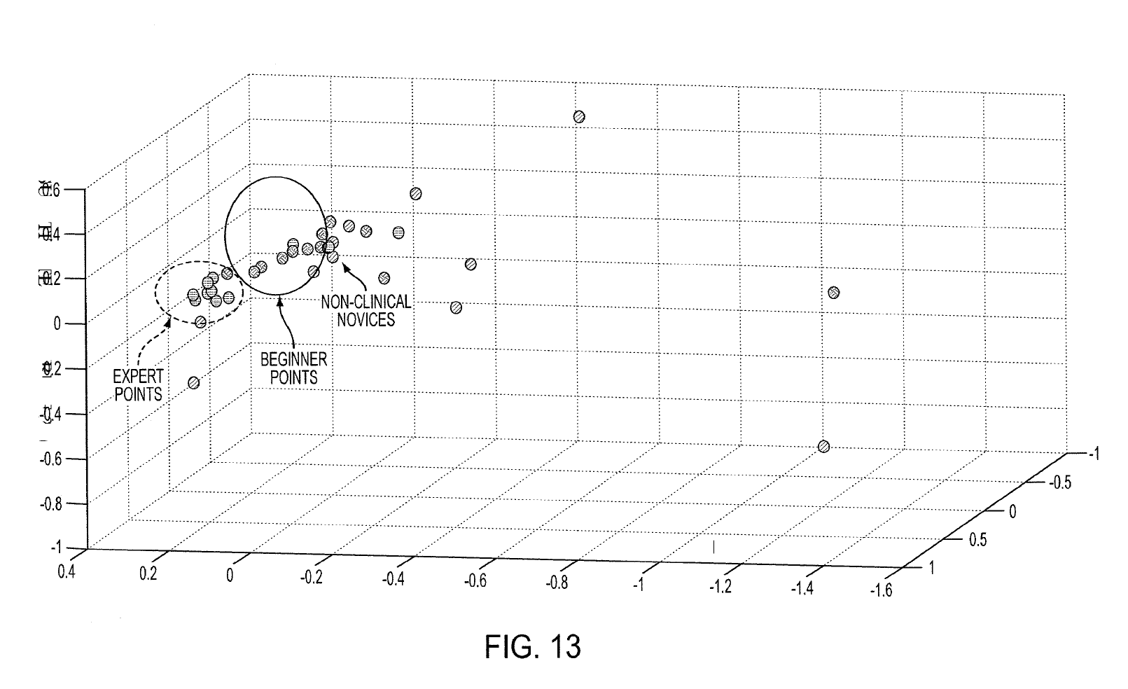

We next trained a binary support vector machine (SVM classifier) on a subset of the trials and used the trained classifier to perform expert vs. non-expert binary classification. 3 expert and 3 non-expert samples were used for training and the trained SVM was applied on the remaining 30 samples. This achieved an 83.3% classification accuracy for suturing. Similarly, 96 dimensions provide a classification accuracy of 76.3% for manipulation. FIG. 13 shows a projection of the suturing Cartesian velocities in three dimensions. The expert trials cluster is well separated from the remaining samples. Note also that the non-clinical users are also separated from trained users with suturing skills.

### Comments

We describe our novel unsupervised data collection infrastructure for robotic surgery training the da Vinci surgical system. This infrastructure is in use for capturing training data at four different training centers (Johns Hopkins, University of Pennsylvania, Children's Hospital, Boston and Stanford).

In comparison to experimental data collection with the intent of detecting current skill levels reported in the literature [7-9, 16-19], we use a benchmarking of skill paradigm for assessment of not just current skill levels, but rather development of learning curves. Learning curves, and their validation is being reported separately. Compared to art, our trainees are motivated by their desire to acquire these skills and become robotic surgeons. They are participating in a training program at the respective centers, and are not practicing with the robot due to our protocol. We therefore, also collect their training times between benchmarking sessions, and the relationship of the training to skill levels is also being reported separately. Finally, we investigate the system operation skills for using the da Vinci. Robotic surgery features a relatively complex man-machine interface, which is one of the reasons for the steep learning curve. Here, we report visualizations that may be used for detecting inefficient use and providing guidance.

We also show that a binary classifier can distinguish between experts and non-experts with accuracies greater than 80%. This work was intended to investigate the need of surgical training in the experimental tasks on a limited set of data. Ongoing analysis is exploring the response times to system events and task errors, and developing methods for distinguishing skill based on the responses to task variability and errors. Other work is exploring supervised and unsupervised methods for operational and surgical skills on larger datasets as well. Those analyses are in preparation for separate submissions.

### REFERENCES FOR EXAMPLE 3

1. Intuitive Surgical Inc, http://www.intuitivesurgical.com/products/faq/index.aspx, 2010.
2. Novick R J, Fox S A, Kiaii B B, Stitt L W, Rayman R, Kodera K, et al. Analysis of the learning curve in telerobotic, beating heart coronary artery bypass grafting: a 90 patient experience. The Annals of thoracic surgery 2003; 76(3):749-753
3. Rodriguez E and Chitwood Jr W R. Outcomes in robotic cardiac surgery, Journal of Robotic Surgery, 2007; 1:19-23
4. Chitwood Jr, W R. Current status of endoscopic and robotic mitral valve surgery. The Annals of thoracic surgery 2005; 79(6):S2248-S2253
5. Ro C Y, Toumpoulis I K, Jr R C A, Imielinska C, Jebara T, Shin S H, et al. A novel drill set for the enhancement and assessment of robotic surgical performance. Studies in Health Technology and Informatics, Proc. Medicine Meeting Virtual Reality (MMVR). 2005; 111:418-421
6. Judkins T N, Oleynikov D, Stergiou N. Objective evaluation of expert and novice performance during robotic surgical training tasks. Surgical Endoscopy 2009; 23(3):590-597
7. Sarle R, Tewari A, Shrivastava A, Peabody J and Menon M. Surgical robotics and laparoscopic training drills. Journal of Endourology. 2004; 18(1):63-67
8. Narazaki K, Oleynikov D, and Stergiou N. Objective assessment of proficiency with bimanual inanimate tasks in robotic laparoscopy. Journal of Laparoendoscopic & Advanced Surgical Techniques. 2007; 17(1):47-52
9. Datta V, Mackay S, Mandalia M, and Darzi A. The use of electromagnetic motion tracking analysis to objectively measure open surgical skill in the laboratory-based model. Journal of the American College of Surgeons. 2001; 193(5):479-485
10. DiMaio S, and Hasser C. The da Vinci Research Interface, Systems and Architectures for Computer Assisted Interventions workshop (MICCAI 2008), http://www.midasjournal.org/browse/publication/622, 2008.
11. Mohr C, and Curet M, The Intuitive Surgical System Skill Practicum. Intuitive Surgical, Inc, 2008
12. Martin J A, Regehr G, Reznick R, MacRae H, Murnaghan J, Hutchison C, et al. Objective structured assessment of technical skill (OSATS) for surgical residents. British Journal of Surgery. 1997; 84(2):273-278
13. Faulkner H, Regehr G, Martin J, Reznick R. Validation of an objective structured assessment of technical skill for surgical residents. Academic Medicine. 1996; 71(12):1363
14. Darzi A, Smith S, and Taffinder N. Assessing operative skill. British Medical Journal. 1999; 318(7188):887
15. Hernandez J D, Bann S D, Munz Y, Moorthy K, Datta V, Martin S, et al. Qualitative and quantitative analysis of the learning curve of a simulated surgical task on the da Vinci system. Surgical Endoscopy. 2004; 18:372-378
16. Lin H C, Shafran I, Yuh D, Hager G D. Towards automatic skill evaluation: Detection and segmentation of robot-assisted surgical motions. Computer Aided Surgery. 2006; 11(5):220-230
17. Verner L, Oleynikov D, Hotmann S, Zhukov L. Measurements of level of surgical expertise using flight path analysis from Da Vinci robotic surgical system. Studies in Health Technology and Informatics 2003; 94:373-378
18. Gallagher A G, Ritter E M, Satava R M, Fundamental principles of validation, and reliability: rigorous science for the assessment of surgical education and training, Surgical Endoscopy. 2003; 17:1525-1529
19. Reiley C E, Hager G D. Task versus Subtask Surgical Skill Evaluation of Robotic Minimally Invasive Surgery, Proc. Medical Image Computing and Computer-Assisted Intervention (MICCAI). 2009; 435-442
20. Gallagher A G, Richie K, McClure N, and McGuigan J. Objective psychomotor skills assessment of experienced, junior, and novice laparoscopists with virtual reality. World Journal of Surgery, 2001; 25(11):1478-1483
21. Aggarwal R. Moorthy K, Darzi a. Laparoscopic skills training and assessment. The British Journal of Surgery. 2004; 91(12):1549-58
22. Judkins T N, Oleynikov D, Stergiou N. Real-time augmented feedback benefits robotic laparoscopic training. Studies in Health technology and Informatics. 2006; 119:243-8
23. Narazaki K, Oleynikov D, Stergiou N. Identifying objective variables for quantifying the extent of proficiency. Urology. 2006:96-103.
24. Ro C Y, Toumpoulis I K, Ashton R C, et al. A novel drill set for the enhancement and assessment of robotic surgical performance. Studies in Health Technology and Informatics. 2005; 111:418-21.
25. Vassiliou M C, Feldman L S, Andrew C G, et al. A global assessment tool for evaluation of intraoperative laparoscopic skills. American journal of surgery. 2005; 190(1):107-13
26. Rosen J, Brown J D, Barreca M, et al. The Blue DRAGON—a system for monitoring the kinematics and the dynamics of endoscopic tools in minimally invasive surgery for objective laparoscopic skill assessment. Studies in Health Technology and Informatics.
27. Sarle R, Tewari A, Shrivastava A, Peabody J, Menon M. Surgical robotics and laparoscopic training drills. Journal of Endourology/Endourological Society. 2004; 18(1):63-6; discussion 66-7

The embodiments illustrated and discussed in this specification are intended only to teach those skilled in the art how to make and use the invention and are not intended to define the scope of the invention. In describing embodiments of the invention, specific terminology is employed for the sake of clarity. However, the invention is not intended to be limited to the specific terminology so selected. The above-described embodiments of the invention may be modified or varied, without departing from the invention, as appreciated by those skilled in the art in light of the above teachings. It is therefore to be understood that, within the scope of the claims and their equivalents, the invention may be practiced otherwise than as specifically described.

1. A system to assist in at least one of the evaluation of or the improvement of skills to perform minimally invasive surgery, comprising:
a minimally invasive surgical system;
a video system arranged to record at least one of a user's interaction with said minimally invasive surgical system or tasks performed with said minimally invasive surgical system; and
a data storage and processing system in communication with said minimally invasive surgical system and in communication with said video system,
wherein said minimally invasive surgical system provides at least one of motion data, ergonomics adjustment data, electrical interface interaction data or mechanical interface interaction data of at least a component of said minimally invasive surgical system in conjunction with time registered video signals from said video system, and
wherein said data storage and processing system processes said at least one of motion data, ergonomics adjustment data, electrical interface interaction data or mechanical interface interaction data to provide a performance metric in conjunction with said time registered video signals to be made available to an expert for evaluation.

2. (canceled)

3. (canceled)

4. (canceled)

5. (canceled)

6. (canceled)

7. (canceled)

8. The system of claim 1, further comprising a display system in communication with said data storage and processing system to display said performance metric in conjunction with said time registered video signals to be made available to said expert for evaluation.

9. The system of claim 8, further comprising an input device in communication with said data storage and processing system to receive expert evaluation from said expert in correspondence with said performance metric and said time registered video.

10. The system of claim 9, further comprising a second display system in communication with said data storage and processing system to display said expert evaluation in conjunction with said time registered video.

11. The system of claim 9, wherein said data storage and processing system is further configured to analyze task performances and provide automated evaluation and expert evaluation together with task video.

12. (canceled)

13. (canceled)

14. The system of claim 11, wherein said automated evaluation includes learning curves of task performance based on configurable task metrics.

15. The system of claim 11, wherein said data storage and processing system is further configured to allow for specific aspects of the automated evaluation to be hidden from review to prevent introduction of bias or a focus on numerical aspects of the automated evaluation by a trainee.

16. The system of claim 11, wherein the automated evaluation includes task-specific feedback for a next training session.

17. The system of claim 16, wherein the automated evaluation includes specific objective feedback for both a mentor and the trainee, with the feedback for the mentor being different from the feedback to the trainee.

18. The system of claim 17, wherein the objective feedback includes task steps in which the trainee is identified to be deficient.

19. The system of claim 17, wherein the objective feedback to the mentor includes a summary of trainee progress, learning curves, population wide trends, comparison of trainee to other trainees, training system limitations, supplies and materials status, and system maintenance issues.

20. The system of claim 17, wherein the automated evaluation is used to vary a training task complexity.

21. The system of claim 17, wherein the automated evaluation is used to vary a frequency of training.

22. The system of claim 17, wherein the automated evaluation is used to select training tasks for the next training session.

23. The system of claim 1, wherein the processing system is configured to perform methods for statistical analysis of skill classification, including identification of proficiency and deficiency.

24. The system of claim 23, wherein the skill classification is binary.

25. The system of claim 23, wherein the skill classification is at least one of multi-class and ordinal.

26. The system of claim 23, wherein the skill classification is based on at least one of a task statistic or a metric of skill.

27. The system of claim 23, wherein the skill classification is based on multiple classification methods.

28. The system of claim 23, wherein the man-machine interaction, ergonomics, and surgical task skills classification is performed separately.

29. The system of claim 23, wherein separate metrics of man-machine interaction, ergonomics and surgical task skills are computed.

30. (canceled)

31. (canceled)

32. (canceled)
